(19) United States
(12) Patent Application Publication
(10) Pub. No.: US 2026/0091740 A1
(43) Pub. Date: Apr. 2, 2026

(54) LOAD CARRIER APPARATUSES AND SYSTEMS

(71) Applicant: Thule Sweden AB, Hillerstorp (SE)

(72) Inventors: Fredrik NEDSTEDT, Forsheda (SE); Simon CATO, Jönköping (SE); Jonas RINGDAHL, Vaggeryd (SE); Hannes FALK, Ulricehamn (SE)

(21) Appl. No.: 19/341,126

(22) Filed: Sep. 26, 2025

Related U.S. Application Data
(60) Provisional application No. 63/700,834, filed on Sep. 30, 2024.

(51) Int. Cl. B60R 9/10; B62H 3/08; B62H 3/10

(52) U.S. Cl. CPC B60R 9/10; B62H 3/08; B62H 3/10

(57) ABSTRACT

A bicycle carrier can include a base, a wheel tray, and a bicycle securement arm. The wheel tray can be configured to receive a wheel of a bicycle. The wheel tray can include a proximal end coupled to the base and a distal end opposite the proximal end. The bicycle securement arm can be rotatably coupled to the wheel tray. The bicycle securement arm can be configured to secure a bicycle to the bicycle carrier.

### CROSS REFERENCE TO RELATED APPLICATION

This application claims priority to U.S. provisional application No. 63/700,834 filed Sep. 30, 2024, the contents of which is hereby incorporated by reference in its entirety.

### BACKGROUND

### Field

The present disclosure relates to load carriers. More specifically, embodiments of the present disclosure relate to vehicle mounted load carriers, for example, bicycle carriers, with a rotatable load arm.

### BACKGROUND

Devices for carrying equipment on a vehicle can be used to transport the equipment from one place to another. In some examples, the load carrier can be secured to the vehicle safely and conveniently via a hitch, typically attached to the rear of the vehicle. Various mechanisms can be used to secure a load (e.g., a bicycle) to the load carrier, for example, straps and securement arms. However, these devices can be cumbersome, difficult to use, lack versatility for different shapes and sizes of bicycles, or fail to securely fasten the bicycle to the load carrier in a sufficient manner. Additionally, current trends have seen more electrification of bicycles and a corresponding increase in the weight of bicycles. Conventional load carriers may already be at a load limit for non-electrified bicycles putting an increased risk of component failure when heavier bicycles and loads are secured to the load carrier.

### BRIEF SUMMARY

Accordingly, there is a need to provide a versatile load carrier system that can secure a load to a load carrier in a variety of configurations and that can accommodate increasing weights and loads secured to the load carrier.

In some embodiments, a bicycle carrier can include a base a wheel tray, and a bicycle securement arm. In some embodiments, the wheel tray can be configured to receive a wheel of a bicycle. In some embodiments, the wheel tray can include a proximal end coupled to the base and a distal end opposite the proximal end. In some embodiments, the bicycle securement arm can be rotatably coupled to the wheel tray and configured to secure a bicycle to the bicycle carrier.

In some embodiments, the bicycle securement arm can be disposed from the proximal end of the wheel tray by a first distance and from the distal end of the wheel tray by a second distance greater than the first distance. In some embodiments, the first distance is less than 200 millimeters.

In some embodiments, the bicycle securement arm can include a bracket, a shaft, and an arm. In some embodiments, the bracket can be directly coupled to the wheel tray. In some embodiments, the shaft can be rotatably mounted on the bracket. In some embodiments, the arm can extend from the shaft and be configured to rotate with the shaft. In some embodiments, the arm of the bicycle securement arm can include an outer arm and an inner arm slideably coupled to the outer arm. In some embodiments, at least a portion of the inner arm can be disposed within the outer arm. In some embodiments, a groove can extend from the proximal end to the distal end of the wheel tray. In some embodiments, the bracket of the bicycle securement arm can extend over the groove of the wheel tray.

In some embodiments, a groove can extend from the proximal end to the distal end of the wheel tray. In some embodiments, the bracket of the bicycle securement arm can be disposed at least partially in the groove of the wheel tray. In some embodiments, a groove can extend from the proximal end to the distal end of the wheel tray. In some embodiments, the groove can be disposed on opposite sides of the bracket of the bicycle securement arm. In some embodiments, the bracket of the bicycle securement arm can couple to side faces of the wheel tray.

In some embodiments, a wheel securement strap can couple to the wheel tray. In some embodiments, the wheel securement strap can be configured to secure the wheel of the bicycle to the wheel tray. In some embodiments, the bicycle securement arm can be configured to secure a frame of the bicycle to the bicycle carrier.

In some embodiments, the bicycle securement arm can configured to rotate beyond a parallel orientation with the wheel tray when the bicycle securement arm is rotated toward the distal end of the wheel tray. In some embodiments, the bicycle securement arm can be prevented from reaching a parallel orientation with the wheel tray when the bicycle securement arm is rotated toward the base. In some embodiments, a housing of the bicycle securement arm can block movement of the bicycle securement arm from reaching a parallel orientation with the wheel tray when the bicycle securement arm is rotated toward the base.

In some embodiments, a load carrier can include a base, a reinforcement member, and a load support arm. In some embodiments, the reinforcement member can couple to a first side of the base. In some embodiments, the load support arm can couple to the reinforcement member and be configured to receive a load. In some embodiments, the reinforcement member can extend into an interior of the load support arm. In some embodiments, a load securement arm can be configured to secure a load to the load carrier. In some embodiments, the load securement arm can couple to the load support arm and the reinforcement member.

In some embodiments, the reinforcement member can include a first assembly plate configured to couple to the first side of the base and a reinforcement arm extending from the first assembly plate. In some embodiments, the first assembly plate can be integrally formed with the reinforcement arm. In some embodiments, an upper surface of the reinforcement arm can contact an upper internal surface of the load support arm. In some embodiments, the load support arm can couple to the first assembly plate of the reinforcement member by a plurality of fasteners.

In some embodiments, the load carrier can include a second reinforcement member and a second load support arm. In some embodiments, the second reinforcement member can couple to a second side of the base opposite the first side of the base. In some embodiments, the second load support arm can couple to the second reinforcement member. In some embodiments, the second reinforcement member can include a second assembly plate and a second reinforcement arm. In some embodiments, an assembly fastener can be configured to couple the first assembly plate and the second assembly plate to the base.

In some embodiments, the assembly fastener can extend through a first plate aperture in the first assembly plate, a first base aperture in the first side of the base, a second base aperture in the second side of the base, and a second plate aperture in the second assembly plate. In some embodiments, a shape of the first plate aperture can be configured to prevent rotation of the assembly fastener.

In some embodiments, the reinforcement arm can include a groove that mates with a groove of the load support arm. In some embodiments, the reinforcement member and the load support arm can extend perpendicularly to the base. In some embodiments, the reinforcement member can extend along between ten percent and thirty percent of a length of the load support arm.

In some embodiments, a load carrier can include a base, a load support arm, and an end cap. In some embodiments, the load support arm ca be configured to receive a load. In some embodiments, the load support arm can include a proximal end coupled to the base and a distal end opposite the proximal end. In some embodiments, the end cap can couple to the distal end of the load support arm. In some embodiments, the end cap can include a plurality of apertures configured to receive an accessory of the load carrier.

In some embodiments, a distal end of the end cap can include a first cross-sectional area and the load support arm can include a second cross-sectional area. In some embodiments, the first cross-sectional area is greater than the second cross-sectional area. In some embodiments, the end cap can include a backstop configured to block a wheel from rotating beyond the end cap and off the load carrier.

In some embodiments, the end cap can include a tab. In some embodiments, the distal end of the load support arm can include an aperture configured to receive the tab to removably couple the end cap to the load support arm. In some embodiments, the aperture can be disposed on a side face of the load support arm.

In some embodiments, the end cap can include a lower tongue disposed below a lower surface of the load support arm. In some embodiments, the lower tongue can be configured to drain fluid from an interior of the load support arm. In some embodiments, a gap can form between the lower tongue of the end cap and the lower surface of the load support surface.

In some embodiments, a cover can couple to the end cap and configured to cover the plurality of apertures in the end cap. In some embodiments, the cover can magnetically couple to the end cap. In some embodiments, the cover can hingedly couple to the end cap. In some embodiments, the plurality of apertures can include an attachment slot configured to receive a load ramp accessory. In some embodiments, a load strap can couple to the load support arm. In some embodiments, the end cap can include a sleeve configured to secure a distal end of the load strap.

In some embodiments, a vehicle mounted load carrier can include a base and a handle. In some embodiments, the base can be configured to couple to a vehicle and rotate from in use position to a lowered position. In some embodiments, the handle can couple to and extend from a distal end of the base. In some embodiments, the handle can include a body portion and a protection protrusion extending from the body portion. In some embodiments, the protection protrusion can include a first portion integrally formed with the body portion of the handle and a cushioning portion coupled to the first portion.

In some embodiments, the protection protrusion can extend from a bottom surface of the handle. In some embodiments, the protection protrusion can have a tapered wedge-shape as the protection protrusion extends away from the body portion of the handle. In some embodiments, the protection protrusion can extend laterally across a center line axis of the base. In some embodiments, the protection protrusion can be configured to contact a ground surface. In some embodiments, the first portion of the protection protrusion can include a first material and the cushioning portion can include a second material different from the first material.

In some embodiments, a load carrier can include a vehicle attachment portion, a base, a locking mechanism, a handle assembly, and a connection linkage. In some embodiments, the base can couple to the vehicle attachment portion. In some embodiments, the base can be configured to carry a load and rotate from a first position to a second position. In some embodiments, the locking mechanism can be configured to secure the base relative to the vehicle attachment portion in the first position. In some embodiments, the handle assembly can couple to a distal end of the base. In some embodiments, the connection linkage can extend in a lengthwise direction of the base and couple to the locking mechanism and the handle assembly. In some embodiments, the handle assembly can be configured to release the locking mechanism to rotate the base from the first position to the second position. In some embodiments, the handle assembly can include a housing and an actuator configured to translate within an interior space of the housing. In some embodiments, the actuator can include a grip portion and a connection portion extending from the grip portion. In some embodiments, the connection portion can include an angled portion extending at an oblique angle from the grip portion and a proximal end coupled to the connection linkage.

In some embodiments, the grip portion and the connection portion are integrally formed. In some embodiments, the connection portion can be offset from an upper surface of the grip portion.

In some embodiments, a vehicle mounted load carrier can include a hub, a base, and a locking mechanism. In some embodiments, the hub can be configured to couple to a vehicle and include a receiver plate. In some embodiments, the receiver plate can include an aperture and a recess. In some embodiments, the base can rotatably couple to the hub. In some embodiments, the locking mechanism can couple to proximal end of the base and bias toward the receiver plate. In some embodiments, the locking mechanism can include a projection and a catch extending from the projection. In some embodiments, the catch can be configured to engage an angled surface formed in the receiver plate at the aperture to lock a relative rotation between the base and the hub.

In some embodiments, the catch can be configured to pull the projection into the aperture when the catch engages the angled surface. In some embodiments, the receiver plate can include an interior facing surface and an outward facing surface. In some embodiments, the angled surface can extend between the outward facing surface and an upper surface of the aperture.

In some embodiments, the base is in an in-use configuration when the projection is disposed in the aperture and the base is in a storage configuration when the projection is disposed in the recess. In some embodiments, the catch can include a surface orientated at an oblique angle relative to the projection. In some embodiments, the catch can be received in a cutout of the projection. In some embodiments, an engagement surface of the catch of the locking mechanism can be approximately parallel to the angled surface of the receiver plate. In some embodiments, the projection can include a cone, a trough, a pyramid, a wedge, or a combination thereof.

In some embodiments, a load attachment accessory can be configured to secure a first load to a load carrier. In some embodiments, the load attachment accessory can include a bracket and a load attachment member. In some embodiments, the bracket can be configured to couple to a load securement arm. In some embodiments, the load securement arm can be configured to secure a second load, larger than the first load, to the load carrier. In some embodiments, the load attachment member can couple to the bracket and be configured to secure the first load to the load securement arm.

In some embodiments, the bracket can surround the load securement arm. In some embodiments, the bracket can include a first shell hingedly coupled and a second shell. In some embodiments, the load attachment member can rotatably couple to the bracket. In some embodiments, the load attachment member can rotate about a plurality of axes relative to the bracket.

In some embodiments, padding can couple to an inner surface of the bracket and be configured to be disposed between the bracket and the load securement arm. In some embodiments, the load attachment member can include a strap head, a J-hook, or a clamp. In some embodiments, the load securement arm can include a housing coupled to the load carrier and a telescoping arm extending from the housing. In some embodiments, the bracket of the load attachment accessory can couple to the housing of the load securement arm.

In some embodiments, a bicycle carrier can include a support beam, a bicycle securement arm, and a repair stand. In some embodiments, the bicycle securement arm can rotatably couple to the support beam and be configured to secure a bicycle to the bicycle carrier. In some embodiments, the repair stand can couple to the bicycle securement arm and be removably coupled to the support beam. In some embodiments, the repair stand can be configured to support the bicycle securement arm in a repair configuration.

In some embodiments, the repair stand can include a support leg and a clamp disposed at a distal end of the support leg. In some embodiments, the clamp can be configured to removably couple around the bicycle securement arm. In some embodiments, the bicycle securement arm can include a housing and a telescoping arm. In some embodiments, the clamp of the repair stand can removably couple around the housing. In some embodiments, the clamp can include a first shell hingedly coupled to a second shell. In some embodiments, the support leg can rotatably couple to the clamp.

In some embodiments, the repair stand can include a support leg and a mounting head disposed at a proximal end of the support leg. In some embodiments, the mounting head can be configured to be removably coupled to the support beam. In some embodiments, the support beam can include a mounting bracket. In some embodiments, a coupling slot can form in the mounting bracket. In some embodiments, the mounting head of the repair stand can be received in the coupling slot to removably couple the repair stand to the support beam. In some embodiments, the coupling slot is L-shaped.

In some embodiments, the coupling slot can include an insertion end and a fixing end. In some embodiments, the mounting head can be inserted into the insertion end and slides towards to the fixing end. In some embodiments, the mounting head of the repair stand can have a first width, the insertion end of the coupling slot has a second width greater than the first width, and the fixing end of the coupling slot has a third width less than the first width. In some embodiments, the mounting head can include a neck having a fourth width less than each of the first width, the second width, and the third width.

In some embodiments, the repair stand can include a support leg having a bar, a tube, an elongated plate, or a combination thereof. In some embodiments, the repair stand can have a non-straight lengthwise shape along a lengthwise axis. In some embodiments, the support beam can include a base or a wheel tray.

Implementations of any of the techniques described above may include a system, a method, a process, a device, and/or an apparatus. The details of one or more implementations are set forth in the accompanying drawings and the description below. Other features will be apparent from the description and drawings, and from the claims.

Further features and advantages, as well as the structure and operation of various embodiments, are described in detail below with reference to the accompanying drawings. It is noted that the disclosure is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate the embodiments and, together with the description, further serve to explain the principles and to enable a person skilled in the relevant art(s) to make and use the embodiments. Objects and advantages of illustrative, non-limiting embodiments will become more apparent by describing them in detail with reference to the attached drawings.

FIG. 1 illustrates a perspective view of a load carrier system, according to an embodiment.

FIG. 2 illustrates a perspective view of a load securement arm coupled to a load support arm, according to an embodiment.

FIG. 3A illustrates a perspective view of a load securement arm in a first configuration relative to a load support arm, according to an embodiment.

FIG. 3B illustrates a perspective view of a load securement arm in a second configuration relative to a load support arm, according to an embodiment.

FIG. 4A illustrates a front perspective view of a portion of a load securement arm, according to an embodiment.

FIG. 4B illustrates a rear perspective view of a portion of a load securement arm, according to an embodiment.

FIG. 5 illustrates an exploded perspective view of a portion of a load carrier including a reinforcement member, according to an embodiment.

FIG. 6 illustrates a perspective view of a reinforcement member, according to an embodiment.

FIG. 7 illustrates a section view of a load carrier including reinforcement members, according to an embodiment.

FIG. 8 illustrates a perspective view of an end cap coupled to a load support arm, according to an embodiment.

FIG. 9 illustrates an exploded perspective view of a load support arm and end cap, according to an embodiment.

FIG. 10A illustrates a side view of a handle and protection protrusion, according to an embodiment.

FIG. 10B illustrates an exploded view of the protection protrusion, according to an embodiment.

FIG. 11 illustrates a perspective view of a handle and protection protrusion, according to an embodiment.

FIG. 12 illustrates a cutaway perspective view of a handle assembly and connection linkage, according to an embodiment.

FIG. 13 illustrates a perspective view of an actuator for a handle assembly, according to an embodiment.

FIG. 14 illustrates a perspective section view of a locking mechanism for a load carrier, according to an embodiment.

FIG. 15 illustrates a section view of a locking mechanism for a load carrier, according to an embodiment.

FIGS. 16A-C illustrate section views of a locking mechanism for a load carrier showing engagement between a catch and a receiver plate, according to an embodiment.

FIG. 17 illustrates a perspective view of a load attachment accessory coupled to a load securement arm, according to an embodiment.

FIG. 18A illustrates a top perspective view of a load attachment accessory, according to an embodiment.

FIG. 18B illustrates a bottom perspective view of a load attachment accessory, according to an embodiment.

FIG. 19 illustrates a perspective view of a load carrier including a repair stand, according to an embodiment.

FIG. 20 illustrates a perspective view of a repair stand coupled to a mounting bracket, according to an embodiment.

FIG. 21 illustrates a perspective view of a clamp of a repair stand, according to an embodiment.

The features and advantages of the embodiments will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Embodiments of the present disclosure are described in detail with reference to embodiments thereof as illustrated in the accompanying drawings. References to “one embodiment,” “an embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Spatially relative terms, such as “beneath,” “below,” “lower,” “above,” “on,” “upper,” “opposite” and the like, may be used herein for ease of description to describe one element or feature's relationship to another element(s) or feature(s) as illustrated in the figures. The spatially relative terms are intended to encompass different orientations of the device in use or in operation in addition to the orientation depicted in the figures. The apparatus may be otherwise oriented (e.g., rotated 90 degrees or at other orientations) and the spatially relative descriptors used herein may likewise be interpreted accordingly.

The term “about” or “substantially” as used herein indicates the value of a given quantity that can vary based on a particular technology. Based on the particular technology, the term “about” or “substantially” can indicate a value of a given quantity that varies within, for example, 1-15% of the value (e.g., ±1%, ±2%, ±5%, ±10%, or ±15% of the value).

The following examples are illustrative, but not limiting, of the present embodiments. Other suitable modifications and adaptations of the variety of conditions and parameters normally encountered in the field, and which would be apparent to those skilled in the art, are within the spirit and scope of the disclosure.

Embodiment 1 of the description—A bicycle carrier including a base; a wheel tray configured to receive a wheel of a bicycle, wherein the wheel tray includes a proximal end coupled to the base, a distal end opposite the proximal end; and a bicycle securement arm rotatably coupled to the wheel tray and configured to secure a bicycle to the bicycle carrier.

Embodiment 2 of the description—The bicycle carrier of embodiment 1, wherein the bicycle securement arm is disposed from the proximal end of the wheel tray by a first distance and from the distal end of the wheel tray by a second distance greater than the first distance.

Embodiment 3 of the description—The bicycle carrier of embodiment 2, wherein the first distance is less than 200 millimeters.

Embodiment 4 of the description—The bicycle carrier of embodiment 1, wherein the bicycle securement arm includes a bracket directly coupled to the wheel tray, a shaft rotatably mounted on the bracket, and an arm extending from the shaft and configured to rotate with the shaft.

Embodiment 5 of the description—The bicycle carrier of embodiment 4, wherein the arm of the bicycle securement arm includes an outer arm and an inner arm slideably coupled to the outer arm, and wherein at least a portion of the inner arm is disposed within the outer arm.

Embodiment 6 of the description—The bicycle carrier of embodiment 4, wherein a groove extends from the proximal end to the distal end of the wheel tray, and wherein the bracket of the bicycle securement arm extends over the groove of the wheel tray.

Embodiment 7 of the description—The bicycle carrier of embodiment 4, wherein a groove extends from the proximal end to the distal end of the wheel tray, and wherein the bracket of the bicycle securement arm in disposed at least partially in the groove of the wheel tray.

Embodiment 8 of the description—The bicycle carrier of embodiment 4, wherein a groove extends from the proximal end to the distal end of the wheel tray, and wherein the groove is disposed on opposite sides of the bracket of the bicycle securement arm.

Embodiment 9 of the description—The bicycle carrier of embodiment 4, wherein the bracket of the bicycle securement arm couples to side faces of the wheel tray.

Embodiment 10 of the description—The bicycle carrier of embodiment 1, further comprising a wheel securement strap coupled to the wheel tray, wherein the wheel securement strap is configured to secure the wheel of the bicycle to the wheel tray.

Embodiment 11 of the description—The bicycle carrier of embodiment 1, wherein the bicycle securement arm is configured to secure a frame of the bicycle to the bicycle carrier.

Embodiment 12 of the description—The bicycle carrier of embodiment 1, wherein the bicycle securement arm is configured to rotate beyond a parallel orientation with the wheel tray when the bicycle securement arm is rotated toward the distal end of the wheel tray.

Embodiment 13 of the description—The bicycle carrier of embodiment 1, wherein the bicycle securement arm is prevented from reaching a parallel orientation with the wheel tray when the bicycle securement arm is rotated toward the base.

Embodiment 14 of the description—The bicycle carrier of embodiment 13, wherein a housing of the bicycle securement arm blocks movement of the bicycle securement arm from reaching a parallel orientation with the wheel tray when the bicycle securement arm is rotated toward the base.

Embodiment 15 of the description—A load carrier including a base; a reinforcement member coupled to a first side of the base; and a load support arm coupled to the reinforcement member and configured to receive a load, wherein the reinforcement member extends into an interior of the load support arm.

Embodiment 16 of the description—The load carrier of embodiment 15, further including a load securement arm configured to secure a load to the load carrier, wherein the load securement arm couples to the load support arm and the reinforcement member.

Embodiment 17 of the description—The load carrier of embodiment 15, wherein the reinforcement member includes a first assembly plate configured to couple to the first side of the base and a reinforcement arm extending from the first assembly plate.

Embodiment 18 of the description—The load carrier of embodiment 17, wherein the first assembly plate is integrally formed with the reinforcement arm.

Embodiment 19 of the description—The load carrier of embodiment 17, wherein an upper surface of the reinforcement arm contacts an upper internal surface of the load support arm.

Embodiment 20 of the description—The load carrier of embodiment 17, wherein the load support arm is coupled to the first assembly plate of the reinforcement member by a plurality of fasteners.

Embodiment 21 of the description—The load carrier of embodiment 17, further including a second reinforcement member coupled to a second side of the base opposite the first side of the base; and a second load support arm coupled to the second reinforcement member, wherein the second reinforcement member includes a second assembly plate and a second reinforcement arm.

Embodiment 22 of the description—The load carrier of embodiment 21, further including an assembly fastener configured to couple the first assembly plate and the second assembly plate to the base.

Embodiment 23 of the description—The load carrier of embodiment 22, wherein the assembly fastener extends through a first plate aperture in the first assembly plate, a first base aperture in the first side of the base, a second base aperture in the second side of the base, and a second plate aperture in the second assembly plate.

Embodiment 24 of the description—The load carrier of embodiment 23, wherein a shape of the first plate aperture is configured to prevent rotation of the assembly fastener.

Embodiment 25 of the description—The load carrier of embodiment 17, wherein the reinforcement arm includes a groove that mates with a groove of the load support arm.

Embodiment 26 of the description—The load carrier of embodiment 15, wherein the reinforcement member and the load support arm extend perpendicularly to the base.

Embodiment 27 of the description—The load carrier of embodiment 15, wherein the reinforcement member extends along between ten percent and thirty percent of a length of the load support arm.

Embodiment 28 of the description—A load carrier including a base; a load support arm configured to receive a load, wherein the load support arm includes a proximal end coupled to the base and a distal end opposite the proximal end; and an end cap coupled to the distal end of the load support arm, wherein the end cap includes a plurality of apertures configured to receive an accessory of the load carrier.

Embodiment 29 of the description—The load carrier of embodiment 28, wherein a distal end of the end cap includes a first cross-sectional area and the load support arm comprises a second cross-sectional area, and wherein the first cross-sectional area is greater than the second cross-sectional area.

Embodiment 30 of the description—The load carrier of embodiment 28, wherein the end cap includes a backstop configured to block a wheel from rotating beyond the end cap and off the load carrier.

Embodiment 31 of the description—The load carrier of embodiment 28, wherein the end cap includes a tab, and wherein the distal end of the load support arm includes an aperture configured to receive the tab to removably couple the end cap to the load support arm.

Embodiment 32 of the description—The load carrier of embodiment 31, wherein the aperture is disposed on a side face of the load support arm.

Embodiment 33 of the description—The load carrier of embodiment 28, wherein the end cap includes a lower tongue disposed below a lower surface of the load support arm, wherein the lower tongue is configured to drain fluid from an interior of the load support arm.

Embodiment 34 of the description—The load carrier of embodiment 33, wherein a gap is formed between the lower tongue of the end cap and the lower surface of the load support surface.

Embodiment 35 of the description—The load carrier of embodiment 28, further including a cover coupled to the end cap and configured to cover the plurality of apertures in the end cap.

Embodiment 36 of the description—The load carrier of embodiment 35, wherein the cover is magnetically coupled to the end cap.

Embodiment 37 of the description—The load carrier of embodiment 35, wherein the cover is hingedly coupled to the end cap.

Embodiment 38 of the description—The load carrier of embodiment 28, wherein the plurality of apertures includes an attachment slot configured to receive a load ramp accessory.

Embodiment 39 of the description—The load carrier of embodiment 28, further including a load strap coupled to the load support arm, wherein the end cap includes a sleeve configured to secure a distal end of the load strap.

Embodiment 40 of the description—A vehicle mounted load carrier including a base configured to couple to a vehicle and rotate from in use position to a lowered position; and a handle coupled to and extending from a distal end of the base, the handle including a body portion and a protection protrusion extending from the body portion, wherein the protection protrusion includes a first portion integrally formed with the body portion of the handle and a cushioning portion coupled to the first portion.

Embodiment 41 of the description—The vehicle mounted load carrier of embodiment 40, wherein the protection protrusion extends from a bottom surface of the handle.

Embodiment 42 of the description—The vehicle mounted load carrier of embodiment 40, wherein the protection protrusion has a tapered wedge-shape as the protection protrusion extends away from the body portion of the handle.

Embodiment 43 of the description—The vehicle mounted load carrier of embodiment 40, wherein the protection protrusion extends laterally across a center line axis of the base.

Embodiment 44 of the description—The vehicle mounted load carrier of embodiment 40, wherein the protection protrusion is configured to contact a ground surface.

Embodiment 45 of the description—The vehicle mounted load carrier of embodiment 40, wherein the first portion of the protection protrusion includes a first material and the cushioning portion includes a second material different from the first material.

Embodiment 46 of the description—A load carrier including a vehicle attachment portion; a base coupled to the vehicle attachment portion, wherein the base is configured to carry a load and rotate from a first position to a second position; a locking mechanism configured to secure the base relative to the vehicle attachment portion in the first position; a handle assembly coupled to a distal end of the base; and a connection linkage extending in a lengthwise direction of the base and coupled to the locking mechanism and the handle assembly, wherein the handle assembly is configured to release the locking mechanism to rotate the base from the first position to the second position, wherein the handle assembly includes a housing and an actuator configured to translate within an interior space of the housing, and wherein the actuator includes a grip portion and a connection portion extending from the grip portion, wherein the connection portion includes an angled portion extending at an oblique angle from the grip portion and a proximal end coupled to the connection linkage.

Embodiment 47 of the description—The load carrier of embodiment 46, wherein the grip portion and the connection portion are integrally formed.

Embodiment 48 of the description—The load carrier of embodiment 46, wherein the connection portion is offset from an upper surface of the grip portion.

Embodiment 49 of the description—A vehicle mounted load carrier including a hub configured to couple to a vehicle and comprising a receiver plate, wherein the receiver plate includes an aperture and a recess; a base rotatably coupled to the hub; and a locking mechanism coupled to proximal end of the base and biased toward the receiver plate, wherein the locking mechanism includes a projection and a catch extending from the projection, wherein the catch is configured to engage an angled surface formed in the receiver plate at the aperture to lock a relative rotation between the base and the hub.

Embodiment 50 of the description—The vehicle mounted load carrier of embodiment 49, wherein the catch is configured to pull the projection into the aperture when the catch engages the angled surface.

Embodiment 51 of the description—The vehicle mounted load carrier of embodiment 49, wherein the receiver plate further includes an interior facing surface and an outward facing surface, and wherein the angled surface extends between the outward facing surface and an upper surface of the aperture.

Embodiment 52 of the description—The vehicle mounted load carrier of embodiment 49, wherein the base is in an in-use configuration when the projection is disposed in the aperture and the base is in a storage configuration when the projection is disposed in the recess.

Embodiment 53 of the description—The vehicle mounted load carrier of embodiment 49, wherein the catch includes a surface orientated at an oblique angle relative to the projection.

Embodiment 54 of the description—The vehicle mounted load carrier of embodiment 49, wherein the catch is received in a cutout of the projection.

Embodiment 55 of the description—The vehicle mounted load carrier of embodiment 53, wherein an engagement surface of the catch of the locking mechanism is approximately parallel to the angled surface of the receiver plate.

Embodiment 56 of the description—The vehicle mounted load carrier of embodiment 49, wherein the projection includes a cone, a trough, a pyramid, a wedge, or a combination thereof.

Embodiment 57 of the description—A load attachment accessory configured to secure a first load to a load carrier, the load attachment accessory including a bracket configured to couple to a load securement arm, wherein the load securement arm is configured to secure a second load, larger than the first load, to the load carrier; and a load attachment member coupled to the bracket and configured to secure the first load to the load securement arm.

Embodiment 58 of the description—The load attachment accessory of embodiment 57, wherein the bracket surrounds the load securement arm.

Embodiment 59 of the description—The load attachment accessory of embodiment 57, wherein the bracket includes a first shell hingedly coupled and a second shell.

Embodiment 60 of the description—The load attachment accessory of embodiment 57, wherein the load attachment member is rotatably coupled to the bracket.

Embodiment 61 of the description—The load attachment accessory of embodiment 60, wherein load attachment member may rotate about a plurality of axes relative to the bracket.

Embodiment 62 of the description—The load attachment accessory of embodiment 57, further comprising padding coupled to an inner surface of the bracket and configured to be disposed between the bracket and the load securement arm.

Embodiment 63 of the description—The load attachment accessory of embodiment 57, wherein the load attachment member includes a strap head, a J-hook, or a clamp.

Embodiment 64 of the description—The load attachment accessory of embodiment 57, wherein the load securement arm includes a housing coupled to the load carrier and a telescoping arm extending from the housing, and wherein the bracket of the load attachment accessory is coupled to the housing of the load securement arm.

Embodiment 65 of the description—A bicycle carrier including a support beam; a bicycle securement arm rotatably coupled to the support beam and configured to secure a bicycle to the bicycle carrier; and a repair stand coupled to the bicycle securement arm and removably coupled to the support beam, wherein the repair stand is configured to support the bicycle securement arm in a repair configuration.

Embodiment 66 of the description—The bicycle carrier of embodiment 65, wherein the repair stand includes a support leg and a clamp disposed at a distal end of the support leg, wherein the clamp is configured to removably couple around the bicycle securement arm.

Embodiment 67 of the description—The bicycle carrier of embodiment 66, wherein the bicycle securement arm includes a housing and a telescoping arm, and the clamp of the repair stand removably couples around the housing.

Embodiment 68 of the description—The bicycle carrier of embodiment 66, wherein the clamp comprises a first shell hingedly coupled to a second shell.

Embodiment 69 of the description—The bicycle carrier of embodiment 66, wherein the support leg is rotatably coupled to the clamp.

Embodiment 70 of the description—The bicycle carrier of embodiment 65, wherein the repair stand includes a support leg and a mounting head disposed at a proximal end of the support leg, wherein the mounting head is configured to be removably coupled to the support beam.

Embodiment 71 of the description—The bicycle carrier of embodiment 70, wherein the support beam includes a mounting bracket, wherein a coupling slot is formed in the mounting bracket, and wherein the mounting head of the repair stand is received in the coupling slot to removably couple the repair stand to the support beam.

Embodiment 72 of the description—The bicycle carrier of embodiment 71, wherein the coupling slot is L-shaped.

Embodiment 73 of the description—The bicycle carrier of embodiment 71, wherein the coupling slot includes an insertion end and a fixing end, and wherein the mounting head is inserted into the insertion end and slides towards to the fixing end.

Embodiment 74 of the description—The bicycle carrier of embodiment 73, wherein the mounting head of the repair stand has a first width, the insertion end of the coupling slot has a second width greater than the first width, and the fixing end of the coupling slot has a third width less than the first width.

Embodiment 75 of the description—The bicycle carrier of embodiment 74, wherein the mounting head further includes a neck having a fourth width less than each of the first width, the second width, and the third width.

Embodiment 76 of the description—The bicycle carrier of embodiment 65, wherein the repair stand includes a support leg comprising a bar, a tube, an elongated plate, or a combination thereof.

Embodiment 77 of the description—The bicycle carrier of embodiment 65, wherein the repair stand has a non-straight lengthwise shape along a lengthwise axis.

Embodiment 78 of the description—The bicycle carrier of embodiment 65, wherein the support beam includes a base or a wheel tray.

Embodiments of the load carriers disclosed herein can be used with, for example, but not limited to, a bicycle carrier(s) or a cargo container. More specifically, the load carriers can include a vehicle mounted bicycle carrier, for example, a hitch-mounted bicycle carrier that can be attached to hitch receiver of a vehicle. The load carriers can be configured to secure one, two, or more bicycles.

As discussed above, it is important to securely mount a load, such as a bicycle, onto a load carrier to reduce motion forces imparted on the bicycle that can result in instability and damage. Therefore, it is important to have a load carrier that is easy to use, for example, uses a single securement arm to secure the load, and that has improved versatility to accommodate different shapes and sizes of bicycles and wheel diameters. Further, with increased electrification in bicycles, and associated weight increases, it is important to have a load carrier that can accommodate a wider range of weights and loads on the load carrier. To accommodate heavier loads, it is important for the load carrier and the load support arms to include additional reinforcement to support the increased weight. Where a load carrier can be rotated between different positions, it is important to provide a locking mechanism that positively engages a locked position to avoid the load carrier slipping and dropping when handled by a user.

Where a load carrier can have multiple accessories that can be coupled separately to the load carrier, it is important that the accessories can be easily assembled to the load carrier via a removably component, such that complex attaching features can be integrated into a molded component while keeping larger structural components relatively feature free to reduce manufacturing costs. Where a load carrier can rotate into multiple positions, including positions that rotate the carrier toward the ground, it is important that the load carrier also include bumpers to prevent the load carrier from hitting the ground and being damaged. Where the load carrier can accommodate smaller loads, such as children's bicycles, it is important to provide an attachment load accessory that can couple to a lower portion of a securement arm to increase the size range of bicycles that can be secured to the load carrier.

Embodiments of load carrier apparatuses, systems, and methods as discussed below can provide versatility for securing loads of different shapes and sizes, attachments for load carrier accessories, protection devices to avoid ground contact of the load carrier, and robust engagement of a locking mechanism to lock a load carrier in an operational configuration.

### Example Load Carrier

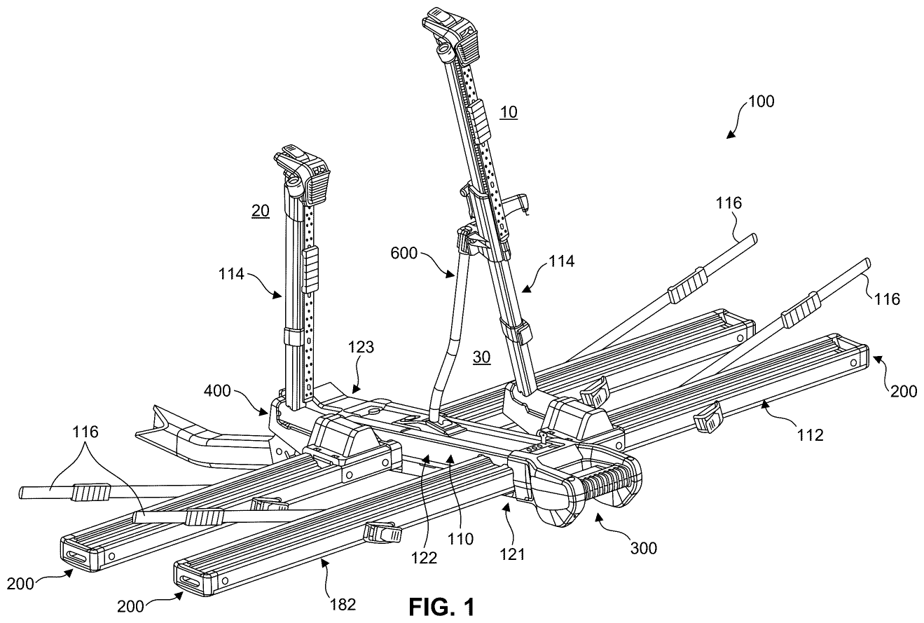

FIGS. 1-7 illustrate a load carrier 100, according to embodiments. Load carrier 100 can be configured to secure a load, for example, a bicycle, using a single load securement arm 114 coupled to a load support arm 112. Load carrier 100 can further include a reinforcement member 118 configured to increase the load carrying capability of load carrier 100. Although load carrier 100 is shown in FIGS. 1-7 as a stand-alone system, the embodiments of this disclosure can be used with other apparatuses and/or systems, such as, but not limited to end cap 200, handle assembly 300, tilt-release locking mechanism 400, load attachment accessory 500, and repair stand 600.

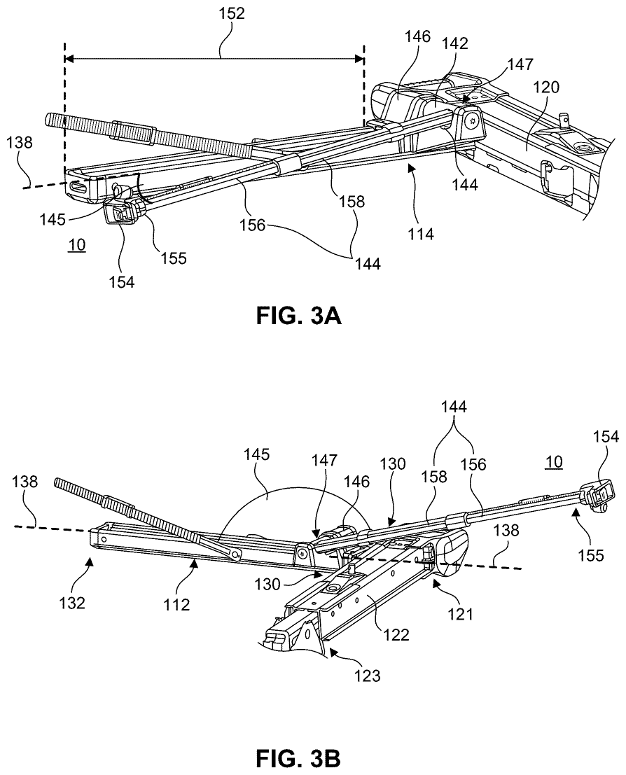

Load carrier 100 can include a base 110, a load support arm 112, and a load securement arm 114, as shown, for example, in FIGS. 1-3B. In some embodiments, load carrier 100 can be a bicycle carrier 100, such that load support arm 112 is a wheel tray 112 configured to receive and support a bicycle wheel, and load securement arm 114 can be a bicycle securement arm 114 configured to secure a bicycle to bicycle carrier 100. In some embodiments, load carrier 100 can include securement straps 116 coupled to load support arm 112 that operate in combination with load securement arm 114 to secure the load to load carrier 100, as shown, for example, in FIGS. 1, 3A, and 3B. In some embodiments, securement straps 116 can be wheel securement straps 116 and be configured to secure a bicycle wheel to wheel tray 112 of bicycle carrier 100. In some embodiments, load carrier 100 can be configured to secure one or more bicycles and include at least one load support arm 112 for each wheel of the one or more bicycles and at least one load securement arm 114 for each of the one or more bicycles. In the illustrative embodiment shown in FIG. 1, load carrier 100 includes four load support arms 112 and two load securement arms 114 to secure at least two bicycles to the load carrier 100.

In the illustrative embodiments shown in FIGS. 1-4B, load support arm 112 can couple to a first side 120 of base 110. In some embodiments, load support arm 112 can extend approximately perpendicular from base 110. Load support arm 112 can include a proximal end 130, a distal end 132, a groove 134, and side faces 136. Proximal end 130 of load support arm 112 can couple to base 110. Distal end 132 can be opposite proximal end 130 and spaced apart from base 110. Groove 134 can extend from proximal end 130 to distal end 132, as shown, for example, in FIG. 1. Groove 134 can be sized to receive a wheel of a bicycle. In some embodiments, groove 134 can be sized to accommodate a road bicycle wheel, a mountain bicycle wheel, a fat tire mountain bicycle wheel, and/or any other type of bicycle wheel. In some embodiments, groove 134 can have a cross-sectional shape that is V-shaped, U-shaped, undulating U-shape, square shaped, or any combination thereof. In some embodiments, groove 134 can include a plurality of ribs 137 that extend along the length of groove 134 and are configured to increase grip between load support arm 112 and a bicycle wheel. Side faces 136 can extend from proximal end 130 to distal end 132 on front and rear side of load support arm 112. In some embodiments, side faces 136 can be substantially flat along the length of load support arm 112. In some embodiments, side faces 136 can include an elongated slot that receives and couples with an accessory, such as a bumper, protection member, detachable light, detachable vehicle information device, or another load carrier accessory.

In the illustrative embodiments shown in FIGS. 1-4B, load securement arm 114 can be coupled to load support arm 112. Load securement arm 114 can be configured to secure a load to load carrier 100. In some embodiments, load securement arm 114 can be a bicycle securement arm 114 that couples to a part of a bicycle to secure the bicycle to the load support arm 112 and load carrier 100. For example, bicycle securement arm 114 can couple to a wheel, a frame, a seat post, a handlebar, a fork, a swing arm, a crank arm, or another suitable component of a bicycle to secure the bicycle to load carrier 100. Accordingly, bicycle securement arm 114 can be more versatile than existing securement arms that secure a bicycle via a wheel only. Load securement arm 114 can include a bracket 140, a shaft 142, an arm 144, and a housing 146 that covers the shaft 142 and the bracket 140.

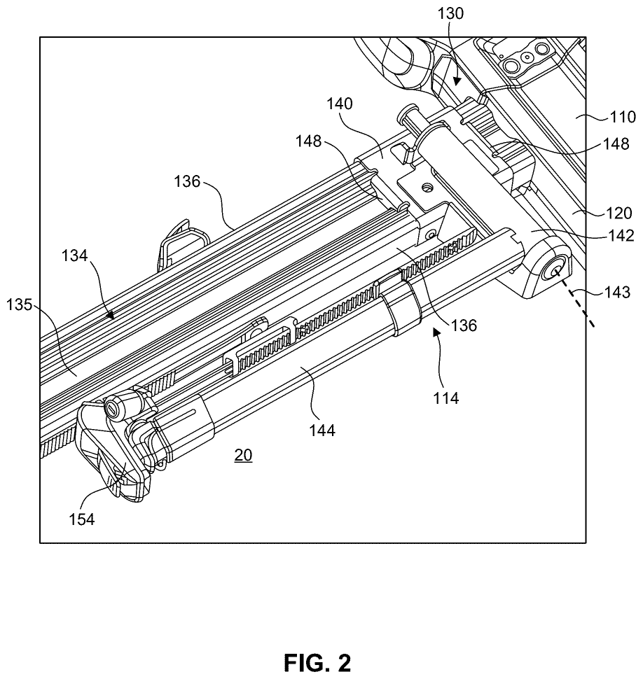

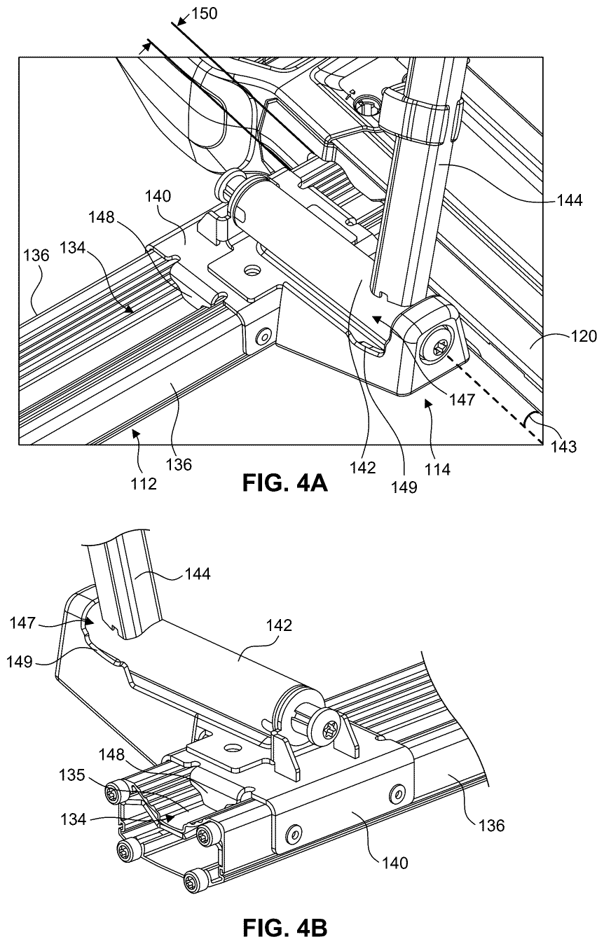

Bracket 140 can couple to load support arm 112 as shown, for example, in FIGS. 2, 4A, and 4B. In some embodiments, bracket 140 can extend over groove 134. In some embodiments, bracket 140 can include one or more legs 148 that extend into groove 134. In some embodiments, legs 148 can contact a base surface 135 of groove 134. In some embodiments, legs 148 can be configured to support load securement arm 114 under moment loads when load securement arm 114 couples to a load or a bicycle during use. In some embodiments, legs 148 can be disposed partially in groove 134 but not in contact with base surface 135 of groove 134. In some embodiments, bracket 140 can be disposed over groove 134 and wrap around and couple to side faces 136 of load support arm 112. In some embodiments, bracket 140 can couple to side faces 136 of load support arm 112 with bolts, screws, rivets, etc., or be welded or adhered to side faces 136. In some embodiments, when arm 144 is coupled to a load during use, such as a bicycle, moment loads from arm 144 can be transferred into load support arm 112 through the coupling members between bracket 140 and side faces 136, or legs 148 through contact with groove 134, or both. In some embodiments, bracket 140 can couple between load support arm 112 and base 110.

In the illustrative embodiments shown in FIGS. 1 and 2, load securement arm 114 is positioned along load support arm 112 closer to proximal end 130 than distal end 132. It may be advantageous to position load securement arm 114 closer to base 110 so that the load securement arm 114 is within reach of more attachment or fixing points on the load that is secured to load carrier 100. For example, where the load is a bicycle, positioning load securement arm 114 close to proximal end 130 of load support arm 112 can allow load securement arm 114 to couple to either the front or rear wheels of the bicycle, the front forks, or any portion of the bicycle frame. In some embodiments, bracket 140 is disposed a first distance 150 from proximal end 130 of load support arm 112, as shown, for example, in FIG. 4A, and a second distance 152 from distal end 132 of load support arm 112, as shown, for example, in FIG. 3A. In some embodiments, second distance 152 is larger than first distance 150 such that bracket 140 and load securement arm 114 is closer to proximal end 130 than distal end 132. In some embodiments, first distance 150 is less than about 400 mm. In some embodiments, first distance 150 is less than about 250 mm. In some embodiments, first distance 150 is about 50 mm.

In the illustrative embodiments shown FIGS. 2-4B, arm 144 can couple to and extend from shaft 142. In some embodiments, arm 144 can extend on a side 136 of load arm 112 closer to a user such that attachment head 154 faces away from the user. In illustrative embodiments shown in FIGS. 1-4B, arm 144 can extend from side 136 that is distal to the user such that attachment head 154 faces the user. Shaft 142 can rotatably couple to bracket 140 such that shaft 142 and arm 144 can rotate relative to bracket 140 and load support arm 112. In some embodiments, shaft 142 can couple above bracket 140 and groove 134. In some embodiments, shaft 142 can extend over groove 134 and past at least one of side faces 136 such that an end of shaft 142 and arm 144 is spaced apart from the side face 136. In some embodiments, shaft 142 can rotate about an axis 143 that is parallel or approximately parallel to base 110 such that arm 144 rotates perpendicular or approximately perpendicular to base 110 and parallel or approximately parallel to load support arm 112. In some embodiments, axis 143 may not be parallel with base 110 such that the rotational path of arm 144 moves toward and away from load support arm 112 through the arc path of arm 144.

In some embodiments, housing 146 can cover all or a substantial portion of bracket 140 and shaft 142, as shown, for example, in FIGS. 1, 3A, and 3B. Housing 146 can include an aperture 147 through which arm 144 can extend and rotate relative to housing 146 and bracket 140. In some embodiments, aperture 147 can include edges 149 that arm 144 can contact to prevent arm 144 from rotating beyond a particular position. In some embodiments, edges 149 can provide rotational limits of arm 144 and shaft 142. In some embodiments, housing 146 is substantially smooth to improve aesthetics of load securement arm 114.

Arm 144 can be configured to rotate through a range of angles 145 relative to a plane 138 of load support arm 112, as shown, for example, in FIGS. 3A and 3B. Plane 138 can align or approximately align with a top surface 139 of load support arm 112. In some embodiments, a range of angles 145 can be limited by edges 149 of housing 146 that block rotation of arm 144 beyond desired angles. In some embodiments, shaft 142 can include a slot that contacts a protrusion of bracket 140 to limit the range of angles 145 and rotation of arm 144. In some embodiments, arm 144 can contact a protrusion of bracket 140 to limit the range of angles 145 and rotation of arm 144.

In some embodiments, when arm 144 is rotated towards distal end 132 of load support arm 112 from a vertical position, arm 144 can rotate beyond parallel with load support arm 112 and below load support arm 112, as shown, for example, in FIG. 3A. In some embodiments, when arm 144 is rotated towards distal end 132 of load support arm 112, angle 145 of arm 144 relative to plane 138 can be between about −10 degrees and about −1 degrees. In some embodiments, when arm 144 is rotated towards proximal end 130 of load support arm 112 from a vertical position, arm 144 can rotate to an oblique angle such that arm 144 does not contact base 110, as shown, for example, in FIG. 3B. In some embodiments, when arm 144 is rotated towards proximal end 130 of load support arm 112, angle 145 of arm 144 relative to plane 138 can be between about 165 degrees and about 175 degrees. In some embodiments, the range of angles 145 through which arm 144 can rotate is between about −10 degrees and 175 degrees. In some embodiments, the range of angles 145 through which arm 144 can rotate is between about −5 degrees and 170 degrees. In some embodiments, the range of angles 145 through which arm 144 can rotate is between about 1 degrees and 160 degrees.

In the illustrative embodiments shown in FIGS. 1-3B, arm 144 can extend from shaft 142 and include attachment head 154 at a distal end 155 configured to couple with and fix the load to load carrier 100. In some embodiments, arm 144 can include inner arm 156 and outer arm 158 such that arm 144 is a telescoping arm 144. Inner arm 156 can translate within outer arm 158 to adjust a length of arm 144. For example, inner arm 156 can translate relative to outer arm 158 such that load securement arm 114 is in an extended configuration 10, as shown in FIGS. 3A and 3B. For example, inner arm 156 can translate relative to outer arm 158 such that load securement arm 114 is in a retracted configuration 20, as shown in FIG. 2. In some embodiments, attachment head 154 can couple to distal end 155 of inner arm 156 such that attachment head 154 can be adjusted to attach with a larger range of different sized and shaped loads. In some embodiments, arm 144 can be a fixed length bar. As will be described in more detail below, in some embodiments, a load attachment accessory 500 can be coupled to arm 144 to attach to smaller loads outside the adjustment range of attachment head 154. In some embodiments, load attachment accessory 500 can be removably coupled to inner arm 156 or outer arm 158 of arm 144.

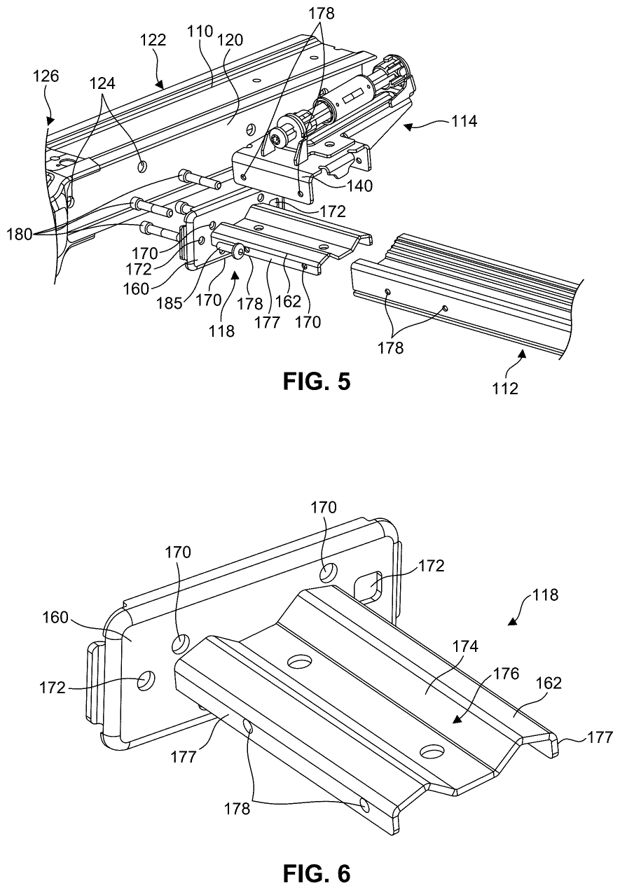

In some embodiments, load carrier 100 can include a reinforcement member 118 configured to increase load carrying capability and stability of load support arm 112, as shown, for example, in FIGS. 5-8. In some embodiments, reinforcement member 118 can be configured to absorb forces acting on load carrier 100 and load support arm 112 when load carrier 100 is in use. For example, reinforcement member 118 can be configured to absorb vertical forces acting through load support arm 112 when load carrier 100 is in use. In some embodiments, reinforcement member 118 can be configured to absorb moment forces of the load securement arm 114 acting around load support arm 112 when load carrier 100 is in use. Reinforcement member 118 can couple to first side 120 of base 110 and extend into an interior of load support arm 112. In some embodiments, reinforcement member 118 can be a sleeve and extend over and/or around an exterior surface of load support arm 112.

In some embodiments, load support arm 112 can couple to base 110 via reinforcement member 118. In some embodiments, reinforcement member 118 can be hidden from view by base 110, load support arm 112, and/or covers 127 at the base 110. Reinforcement member 118 can be configured to increase strength and rigidity of load support arm 112 by providing additional load carrying material close to the attachment with base 110. For example, at the attachment of load support arm 112 and reinforcement member 118 with base 110, there are at least two layers of support material to accommodate and distribute moment loads applied along load support arm 112. This can be advantageous to increase load capability of the load carrier 100 such that load carrier 100 can support and a wider range of loads. In addition, the wall thicknesses of load support arm 112 can be smaller, and strength can be added through the addition of reinforcement member 118. For example, where load carrier 100 is configured to support a bicycle, load carrier 100 can support light bicycles, such as children's bicycles or lightweight road bicycles, as well as heavier bicycles, such as electric-bicycles or downhill bicycles weighing up to, for example, 30 kilograms.

In some embodiments, reinforcement member 118 can include an assembly plate 160 and a reinforcement arm 162 extending from assembly plate 160 as shown, for example, in FIGS. 5 and 6. In some embodiments, assembly plate 160 and reinforcement arm 162 can be integrally formed as a single-piece component. In some embodiments, assembly plate 160 and reinforcement arm 162 can be coupled together by bolts, rivets, or other suitable joining elements or devices. In some embodiments, assembly plate 160 and reinforcement arm 162 can be joined together by welding. Assembly plate 160 can include a plurality of plate apertures 170 configured to receive a plurality of fasteners 180 that couple with load support arm 112. As shown, for example, in FIG. 5, fasteners 180 can extend from a back-side of assembly plate 160 through plate apertures 170 and extend from assembly plate 160 parallel or approximately parallel to reinforcement arm 162. In the illustrative embodiment shown in FIG. 5, four fasteners 180 extend through four plate apertures 170, but more or less fasteners 180 can be used. In some embodiments, proximal end 130 of load support arm 112 extends over reinforcement arm 162 and is coupled to assembly plate 160 by fasteners 180. Some load forces applied to load support arm 112 can be transferred to reinforcement member 118 via fasteners 180. In some embodiments, assembly plate 160 includes assembly aperture 172 configured to receive assembly fastener 185 to couple assembly plate 160 to base 110. In the illustrative embodiments shown in FIGS. 5 and 6, assembly plate 160 can include two assembly apertures 172 configured to receive two assembly fasteners 185, but more or less fasteners 185 can be used.

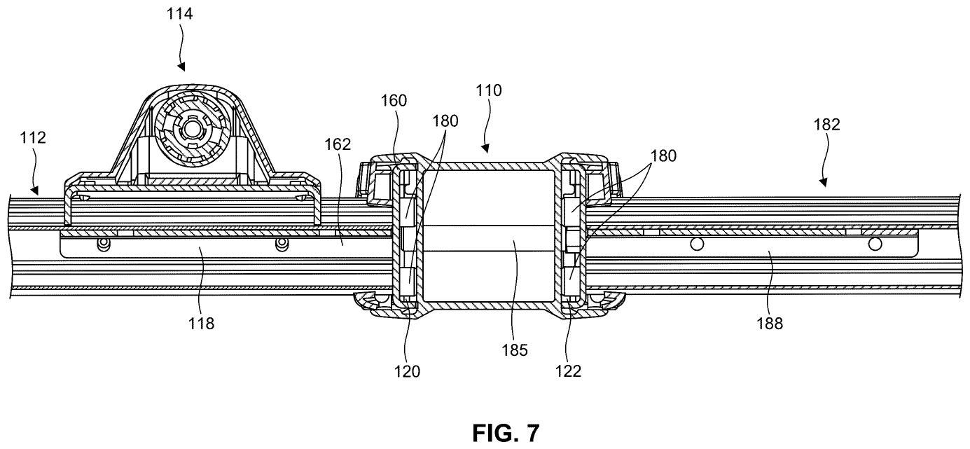

In some embodiments, reinforcement arm 162 extends from assembly plate 160 and into an interior of load support arm 112 and is configured to support load support arm 112, as shown, for example, in FIGS. 5 and 7. In some embodiments, reinforcement arm 162 extends approximately perpendicular to assembly plate 160 and base 110. In some embodiments, reinforcement arm 162 can extend between about 5 percent and about 30 percent of a length of load support arm 112 between proximal end 130 and distal end 132. In some embodiments, reinforcement arm 162 can extend between about 10 percent and about 20 percent of the length of load support arm 112. In some embodiments, reinforcement arm 162 can extend about 12 percent of the length of load support arm 112.

In some embodiments, reinforcement arm 162 can be configured to directly couple with load securement arm 114 and load support arm 112, as shown, for example, in FIGS. 5 and 7. In some embodiments, reinforcement arm 162 can be configured to indirectly couple with load securement arm 114 via load support arm 112. In the illustrative embodiment shown in FIG. 5, reinforcement arm 162, load support arm 112, and bracket 140 each have corresponding apertures 178 to couple the assembly of components 112, 140, 162 together. This assembled configuration, or reinforcing sandwich structure, can be advantageous to increase load capability, rigidity, and stiffness of load securement arm 114 such that load securement arm 114 can support heavier loads that are attached to load carrier 100. For example, moment loads exerted on load securement arm 114 can be distributed through both load support arm 112 and reinforcement member 118. Accordingly, reinforcement member 118 increases load carrying capability of both the load support arm 112 and the load securement arm 114 such that load carrier 100 overall has increased load carrying capability over conventional load carriers.

Reinforcement arm 162 can include an upper surface 174, a groove 176, and side walls 177, as shown, for example, in FIG. 6. Groove 176 can be sized and shaped to mate with the interior shape of groove 134 of load support arm 112 when reinforcement arm 162 is inserted into load support arm 112. Groove 176 and side walls 177 can increase stiffness of reinforcement arm 162. Upper surface 174 of reinforcement arm 162 can be configured to contact an upper interior surface 133 of load support arm 112. In some embodiments, upper surface 174 can have a similar profile shape to the upper interior surface 133 of load support arm 112. In some embodiments, a substantial area of upper surface 174 can contact the upper interior surface 133 of load support arm 112 to distribute load forces from load support arm 112 into reinforcement member 118. In some embodiments, load forces from load support arm 112 can be transferred through reinforcement member 118 via fasteners 180 and/or upper surface 174 of reinforcement arm 162.

In some embodiments, reinforcement member 118 can couple to first side 120 of base 110 and a second reinforcement member 188 can couple to a second side 122 of base 110 opposite first side 120. In some embodiments, reinforcement member 118 can be substantially similar to second reinforcement member 188. Second reinforcement member 188 can couple with second load support arm 182 to support the load. For example, a first wheel of a bicycle can be supported by load support arm 112 and a second wheel of the bicycle can be support by second load support arm 182. In the illustrative embodiment shown in FIG. 7, load securement arm 114 is coupled only to load support arm 112, and no load securement arms are coupled to second load support arm 182. In some embodiments, reinforcement member 118 couples to second reinforcement member 188 with assembly bolt 185 to clamp base 110 therebetween and couple reinforcement members 118, 188 and base 110 together.

First base apertures 124 can be formed through first side 120 of base 110 as shown, for example, in FIG. 5. Second base apertures 126 can be formed through second side 122 of base 110. Assembly apertures 172 of reinforcement members 118, 188 can align with base apertures 124, 126. Assembly fasteners 182 can extend through assembly apertures 172, and base apertures 124, 126 to couple reinforcement member 118, 188 and base 110 together. In some embodiments, one of assembly apertures 172 can include a shape that matches a cross-sectional shape of a portion of assembly fastener 185 such that the shaped aperture 172 prevents assembly fastener from rotating during assembly. In some embodiments, the shaped aperture 172 can be a square, a rectangle, an oval, a triangle, or any other suitable polygonal shape that can prevent rotation of the assembly fastener 185.

### Example End Cap

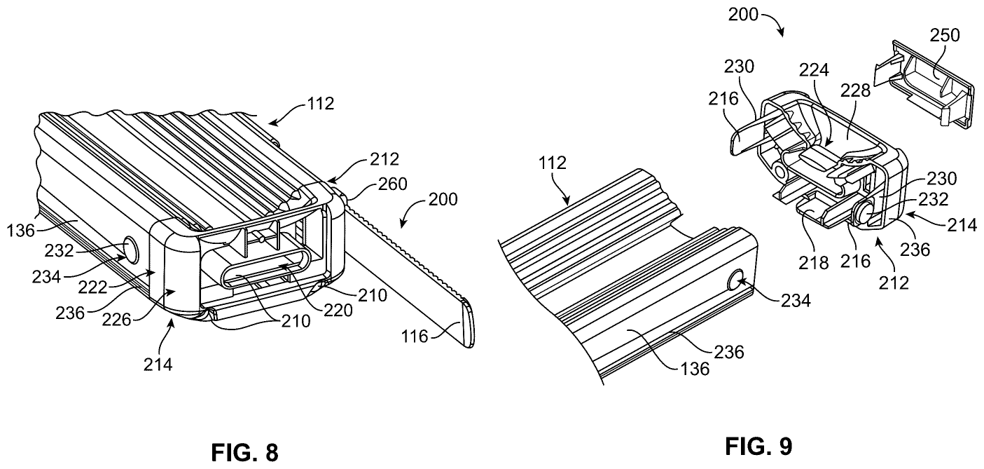

FIGS. 8 and 9 illustrate an end cap 200, according to embodiments. End cap 200 can be configured to couple to load carrier 100 and detachably couple a plurality of accessories to load carrier 100. Although end cap 200 is shown in FIGS. 8 and 9 as a stand-alone system coupled to load carrier 100, the embodiments of this disclosure can be used with other apparatuses and/or systems, such as, but not limited to handle assembly 300, tilt-release locking mechanism 400, load attachment accessory 500, and repair stand 600.

End cap 200 can couple to a distal end 132 of load support arm 112, as shown for example, in FIGS. 8 and 9. In some embodiments, end cap 200 can couple to a distal end of base 110. End cap 200 can include one or more apertures 210, a proximal end 212, a distal end 214, one or more tabs 216, and lower tongue 218. Apertures 210 can be formed through end cap 200. In some embodiments, apertures 210 are formed through distal end 214. Apertures 210 can be configured to receive and couple with accessories for load carrier 100. For example, apertures 210 can receive accessories such as protective bumpers configured to prevent load support arm from contacting a ground surface, vehicle identification holders such as license plate holders, lights that illuminate load carrier 100 or act as taillights and/or turn signals for a vehicle, cable management systems, or other suitable load carrier accessories. In some embodiments, apertures 210 can include an attachment slot 220. Attachment slot 220 can be configured to receive, for example, an end of a load ramp for rolling a load or bicycle onto load carrier 100.

Proximal end 212 of end cap 200 can couple with distal end 132 of load support arm 112. Proximal end 212 of end cap 200 can include groove portion 224, as shown, for example, in FIG. 9. Groove portion 224 extends groove 134 of load support arm 112 beyond distal end of load support arm 112. In some embodiments, proximal end 212 of end cap 200 can have a cross-sectional area 222 that is similar to a cross-sectional area of load support arm 112. Distal end 214 of end cap 200 can be opposite proximal end 212. As shown, for example, in FIG. 9, distal end 214 of end cap 200 can include a backstop 228 that forms a terminating wall of groove 134, 224. In some embodiments, backstop 228 can be configured to block a bicycle wheel from rolling beyond end cap 200 and off load support arm 112. In some embodiments, distal end 214 of end cap 200 can have a cross-sectional area 226 greater than the cross-sectional area 222 of proximal end 212.

In some embodiments, end cap 200 can be removably coupled to load support arm 112. In the illustrative embodiment shown in FIG. 9, tabs 216 of end cap 200 can include cantilever arm 230 and protrusion 232 extending from cantilever arm 230. Distal end 132 of load support arm 112 can include apertures 234 formed through side faces 136. In some embodiments, to attach end cap 200 on to load support arm 112, tabs 216 can be deflected inward toward groove portion 224 so that tabs 216 can be inserted into the interior of load support arm 112. Tabs 216 can be translated into the interior of load support arm 112 until apertures 234 formed through side faces 136 receive protrusions 232. As shown, for example, in FIGS. 8 and 9, protrusions 232 and apertures 234 have similar shapes such that protrusions 232 are flush with side faces 136 when end cap 200 is assembled to load support arm 112. In some embodiments, it can be advantageous for end cap 200 to be removably coupled to load support arm 112 to provide access to accessory slots 236 in side faces 136 of load support arm 112. As shown, for example, in FIGS. 8 and 9, accessory slots 236 are open when end cap 200 is not installed, but end cap 200 closes off accessory slots 236 to prevent an accessory installed in slots 236 from becoming detached from load support arm 112 when end cap 200 is assembled.

In some embodiments, lower tongue 218 extends below load support arm 112 when end cap 200 is assembled to load support arm 112, as shown, for example in FIG. 9. In some embodiments, lower tongue 218 can be spaced apart from a lower surface of load support arm 112 to form a gap therebetween. In some embodiments, lower tongue 218 can be configured to drain fluid from an interior of load support arm 112.

In some embodiments, end cap 200 can include a cover 250, as shown, for example, in FIG. 9. Cover 250 can be configured to cover apertures 210 to prevent dirt, water, and debris from entering the interior of load support arm 112. In some embodiments, cover 250 can be magnetically coupled to distal end 214 of end cap 200. In some embodiments, cover 250 can be hingedly coupled to distal end 214 of end cap 200. In some embodiments, cover 250 can include tabs, similar to tabs 216, to positively engage distal end 214 of end cap 200 to couple therewith (e.g., via snap-fit).

In some embodiments, end cap 200 can include a sleeve 260 configured to receive a distal end of securement strap 116. In some embodiments, sleeve 260 can be configured to secure securement strap 116 to end cap 200 when securement strap 116 is not being used to secure a load to load carrier 100. In some embodiments, end cap 200 can include a slot that receives a distal end of securement strap 116 to secure securement strap 116 to end cap 200. In some embodiments, a slot can be formed between end cap 200 and distal end 132 of load support arm 112 and be configured to receive a distal end of securement strap 116 to secure securement strap 116 to load support arm 112. In some embodiments, end cap can include a clip configured to releasably couple with a distal end of securement strap 116 to secure securement strap 116 to end cap 200. In some embodiments, end cap 200 can include a magnet to magnetically couple to a metallic or magnet embedded in securement strap 116 to secure securement strap 116 to end cap 200.

### Example Handle Assembly

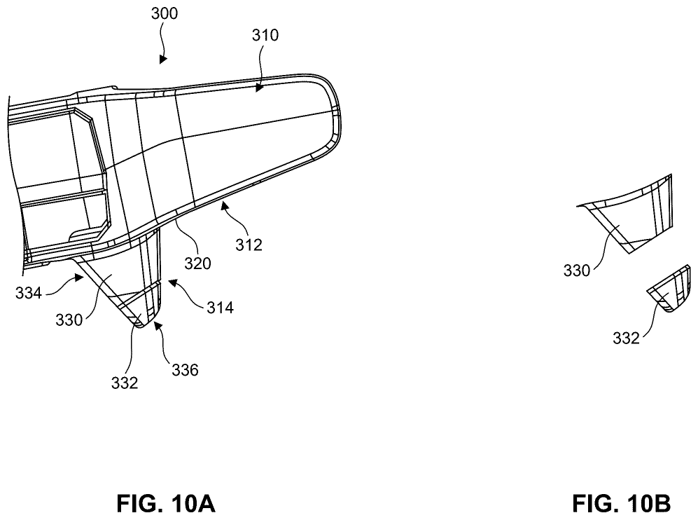

FIGS. 10A-13 illustrate handle assembly 300, according to embodiments. Handle assembly 300 can couple to base 110 and extend away from base 110. Handle assembly 300 can include an actuator 350 to disengage a locking mechanism 400 to allow rotation of base 110 between in-use, lowered, and storage configurations. Handle assembly 300 can include protection protrusion 314, which can be configured to contact a ground surface before base 110 or load support arms 112, to prevent damage of load carrier 100. Although handle assembly 300 is shown in FIGS. 10A-13 as a stand-alone system, the embodiments of this disclosure can be used with other apparatuses and/or systems, such as, but not limited to load carrier 100, end cap 200, tilt-release locking mechanism 400, load attachment accessory 500, and repair stand 600.

In the illustrative embodiments shown in FIGS. 10A-13, handle assembly 300 extends from a distal end 121 of base 110. Handle assembly 300 can include housing 310 and actuator 350. Housing 310 can be fixed at distal end 121 of base 110 and moves with base 110. Housing 310 can include body portion 312 and protection protrusion 314 extending away from body portion 312. Body portion 312 can form an external shell of the portions of handle assembly 300 with which a user interacts. For example, body portion 312 can include an aperture extending approximate centrally through body portion, through which a user can place their fingers in order to hold handle assembly and apply force to lift load carrier 100, or support downward motion of load carrier 100. In the illustrative embodiments shown in FIGS. 10A-12, body portion 312 can include a bottom surface 320 and interior space 322.

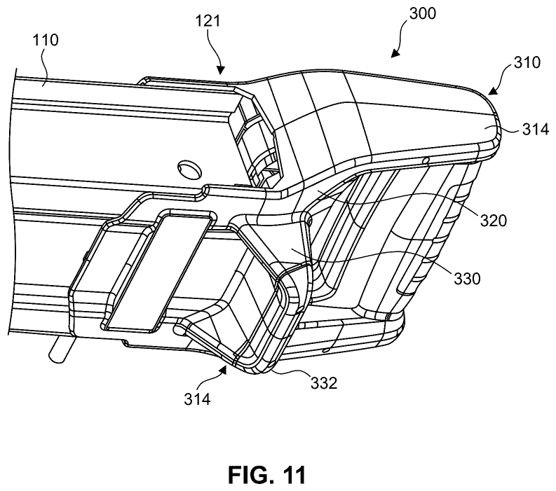

Protection protrusion 314 extends away from bottom surface 320 of body portion 312, as shown, for example, in FIGS. 10A and 11. Protection protrusion 314 can be configured to contact a ground surface before other components of load carrier 100, thereby protecting load carrier 100 from unwanted contact with the ground surface. This can be advantageous when a user moves base 110 into a lowered configuration that is toward the ground surface because protection protrusion 314 will contact the ground surface first to prevent damaging other components or accessories on load carrier 100. In some embodiments, protection protrusion 314 can have a tapered wedge-shape as protection protrusion 314 extends away from bottom surface 320 of body portion 312. In some embodiments, protection protrusion 314 can extend laterally across a center line axis of the base 110 without breaks or recesses. In the illustrative embodiment shown in FIG. 11, protection protrusion 314 can include a cutout 315 on a backside of protection protrusion 314 that can allow a user to grip protection protrusion 314 to assist in lifting or maneuvering handle assembly 300 when moving base 110 between different configurations.

In some embodiments, protection protrusion 314 can include first portion 330 and a cushioning portion 332 extending from first portion 330. In some embodiments, first portion 330 can be integrally formed with body portion 312. In some embodiments, cushioning portion 332 can be removably coupled with first portion 330, as shown, for example, in FIG. 10B. In some embodiments, first portion 330 can have first material 334. In some embodiments, first portion 330 and body portion 312 can include first material 334. In some embodiments, cushioning portion 332 can include second material 336. In some embodiments, second material 336 can be different from first material 334. In some embodiments, second material 336 can be rubber, silicone, plastic, or any other suitable shock or impact absorbing material.

In some embodiments, actuator 350 can be configured to translate within interior space 322 of housing 310 and release locking mechanism 400 such that base 110 can be rotated between storage, in-use, and lowered configurations. In some embodiments, base 110 can be rotatably coupled to hub 102 and locked in a configuration by locking mechanism 400. Actuator 350 of handle assembly 300 can couple to locking mechanism 400, for example, via connector linkage 340. In some embodiments, connector linkage 340 can extend through base 110 and couple between locking mechanism 400 and actuator 350. Connector linkage 340 can be configured to transfer movements from an actuator 350 of handle assembly 300 to locking mechanism 400. When a user operates actuator 350, actuator 350 can be translated relative to housing 310 and base 110, which in turn translates connector linkage 340 and a projection 410 of locking mechanism 400. The resulting translation of projection 410 can disengage projection 410 of locking mechanism 400, for example, from a receiver plate 430 in hub 102, allowing locking mechanism 400 and base 110 to rotate relative to hub 102. When actuator 350 is released, a spring can bias projection 410 toward receiver plate 430 to lock locking mechanism 400 with hub 102 and prevent rotation of base 110 relative to hub 102.

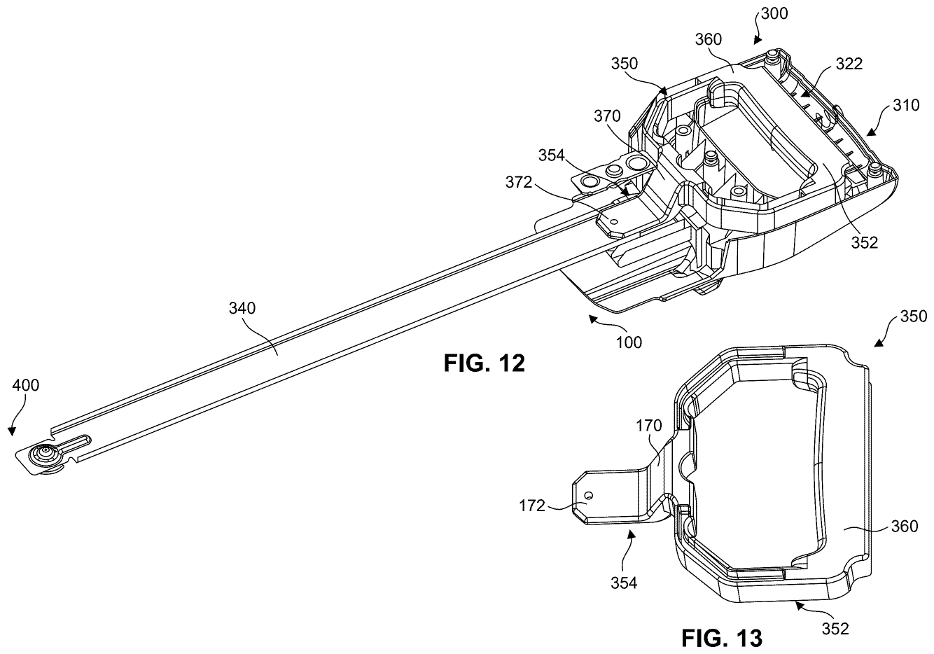

In the illustrative embodiment shown in FIG. 12, actuator 350 can be configured to translate within interior space 322 of housing 310. In some embodiments, housing 310 can include one or more grooves that guide actuator 350 along a linear path during actuation. Actuator 350 can include grip portion 352 and connector portion 354 as shown, for example, in FIGS. 12 and 13. In some embodiments, grip portion 352 and connector portion 354 can be integrally formed as a single piece component. In some embodiments, grip portion 352 and connector portion 354 can be removably coupled together.

In some embodiments, grip portion 352 can include an upper surface 360. A user can grasp grip portion 352 to translate actuator 350. In some embodiments, grip portion 352 can have an ergonomic shape so that a user can securely hold grip portion 352. In some embodiments, grip portion 352 can have finger grooves or a formed pattern or texture in the outer surface of grip portion 352 to improve grip by a user. In some embodiments, grip portion 352 can be made from a material that increases friction with the user's hand, such as a rubber compound, grip tape, or other similar materials and textures.

Connector portion 354 can extend away from grip portion 352 and be configured to couple to connector linkage 340, as shown, for example, in FIGS. 12 and 13. Connector portion 354 can include an angled portion 370 and a proximal end 372. In some embodiments, proximal end 372 of connector portion 354 can be offset from upper surface 360 of grip portion 352. In some embodiments, proximal end 372 of connector portion 354 can extend in a plane that is parallel to a plane of upper surface 360 of grip portion 352. As shown, for example, in FIG. 12, proximal end 372 of connector portion 354 can couple to connector linkage 340. Angled portion 370 can form a wedge between grip portion 352 and proximal end 372. Angled portion 370 can extend at an oblique angle relative to upper surface 360 of grip portion 352. In some embodiments, connector portion 354 can be sheet metal, an extruded plate, a rod, a 3D printed object, or any other suitable formed material.

### Example Tilt Release Locking Mechanism

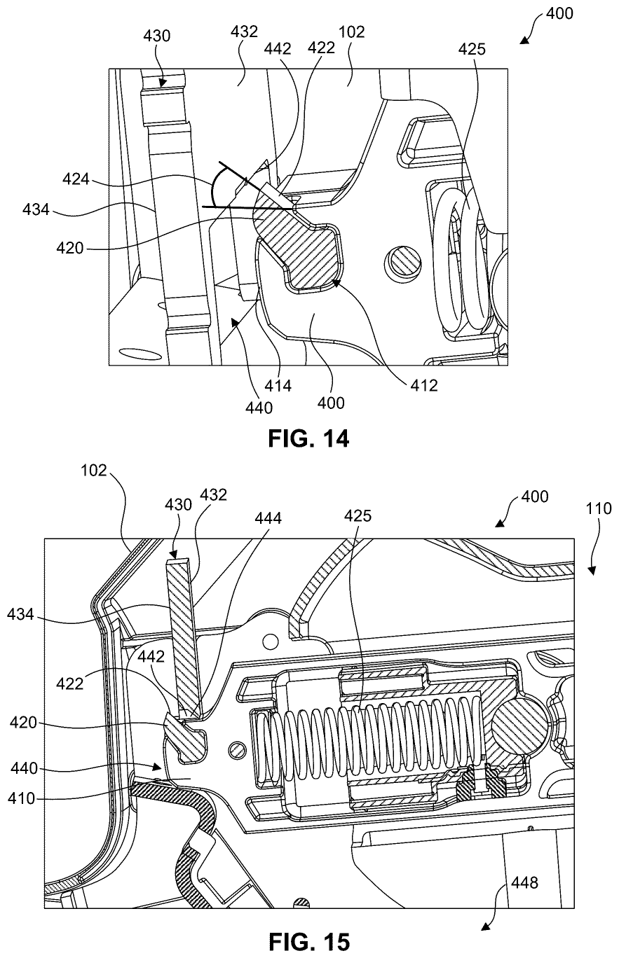

FIGS. 14-16C illustrate locking mechanism 400, according to embodiments. Locking mechanism 400 can be configured to engage receiver plate 430 in a plurality of positions to lock a relative rotation between base 110 and hub 102. In some embodiments, locking mechanism 400 can include catch 420 that engages with receiver plate 430 to pull a projection 410 into engagement with receiver plate 430. Although tilt-release locking mechanism 400 is shown in FIGS. 14-16C as a stand-alone system, the embodiments of this disclosure can be used with other apparatuses and/or systems, such as, but not limited to load carrier 100, end cap 200, handle assembly 300, load attachment accessory 500, and repair stand 600.

In some embodiments, locking mechanism 400 and base 110 can be pivotally coupled to hub 102 via a pivot point. In some embodiments, locking mechanism 400 can be substantially disposed within an interior cavity of hub 102. Hub 102 can include a receiver plate 430 disposed in the interior cavity of hub 102 and configured to receive a projection 410 of locking mechanism 400. In some embodiments, receiver plate 430 can extend around a portion of the internal perimeter of hub 102. In some embodiments, receiver plate 430 can be a sintered part, a casting, a formed metal piece, or a machined block. Receiver plate 430 can include an interior facing surface 432, and an outward facing surface 434, an aperture 440, and a recess 448 as shown, for example in FIG. 15. Interior facing surface 432 can face the interior cavity of hub 102. Outward facing surface 434 of receiver plate 430 can be opposite interior facing surface 432.

Receiver plate 430 can be configured to receive a projection 410 of locking mechanism 400 in aperture 440 and/or recess 448 to lock a relative position of locking mechanism 400 relative to hub 102 as shown, for example, in FIG. 15. In some embodiments, when locking mechanism 400 is received in aperture 440, base 110 can be in an in-use configuration. In some embodiments, when locking mechanism 400 is received in recess 448, base 110 can be in a storage or upright configuration. In some embodiments, when locking mechanism 400 is not received in either aperture 440 or recess 448, base 110 can be in a lowered configuration. In some embodiments, receiver plate 430 can include a plurality of apertures 440 or recesses 448 based on the number of different positions load carrier 100 can be moved into (e.g. fold-back, storage, in-use, loading, lowered, etc.). In some embodiments, hub 102 can include a plurality of receiver plates 430 assembled in hub 102. For example, a first receiver plate 430 can include aperture 440, and a second receiver plate 430 can include recess 448.

In some embodiments, aperture 440 can machined into receiver plate 430. Aperture 440 can include an upper surface 442. An angled surface 444 can be formed into upper surface 442 of aperture 440 and configured to engage with a catch 420 of locking mechanism 400. In some embodiments, angled surface 444 can extend between upper surface 442 and outward facing surface 434 at an oblique angle relative to upper surface 442. In some embodiments, recess 448 can be formed into receiver plate 430 by forming plate material to include a recess shape (e.g. cold working, hydroforming, etc.). In some embodiments, recess 448 can include an inverted cone, an inverted trough, an inverted pyramid, an inverted wedge, or a combination thereof.

Locking mechanism 400 can include a projection 410, a catch 420, and a spring 425 configured to bias projection 410 into engagement with receiver plate 430 as shown, for example, in FIGS. 14 and 15. In some embodiments, locking mechanism 400 can couple with proximal end 123 of base 110. In some embodiments, projection 410 can extend away from base 110 and be configured to engage and interlock with receiver plate 430 to lock a relative rotation between base 110 and hub 102. For example, when projection 410 is received in aperture 440, base 110 is in an in-use configuration. In some embodiments, when projection 410 is received in recess 448, base 110 is in a storage or upright configuration. In some embodiments, projection 410 can include a cone, a trough, a pyramid, a wedge, or a combination shapes.

In some embodiments, spring 425 can be configured to bias projection 410 toward receiver plate 430. In some embodiments, actuator 350 can be actuated against the force from spring 425 to translate projection 410 and connector linkage 340 towards distal end 121 of base 110 to disengage projection 410 from receiver plate 430 such that base 110 can be rotated relative to hub 102.

Catch 420 can be configured to extend from projection 410 and engage receiver plate 430, for example, angled surface 444 of receiver plate 430, as shown, for example, in FIGS. 14, 15, and 16A-C. In some embodiments, catch 420 can engage angled surface 444 of receiver plate 430 to pull projection 410 into engagement with aperture 440. In some embodiments, catch 420 can engage angled surface 444 of receiver plate 430 when a projection 410 is translated away from receiver plate 430 to temporarily prevent disengagement between projection 410 and aperture 440. In some embodiments, catch 420 is received in a cutout 412 of projection 410, as shown, for example, in FIG. 14. In some embodiments, catch 420 extends diagonally outward from projection 410. In some embodiments, catch 420 extends forward and above projection 410 when base 110 is in the in-use configuration. In some embodiments, catch 420 extends above projection 410 and approximately aligns with a forward face 414 of projection 410. Catch 420 can include an engagement surface 422. Engagement surface 422 is configured to contact angled surface 444 of receiver plate 430. In some embodiments, engagement surface 422 extends at an oblique angle 424 relative to projection 410. In some embodiments, engagement surface 422 is approximately parallel with angled surface 444 when base 110 is in the in-use configuration.

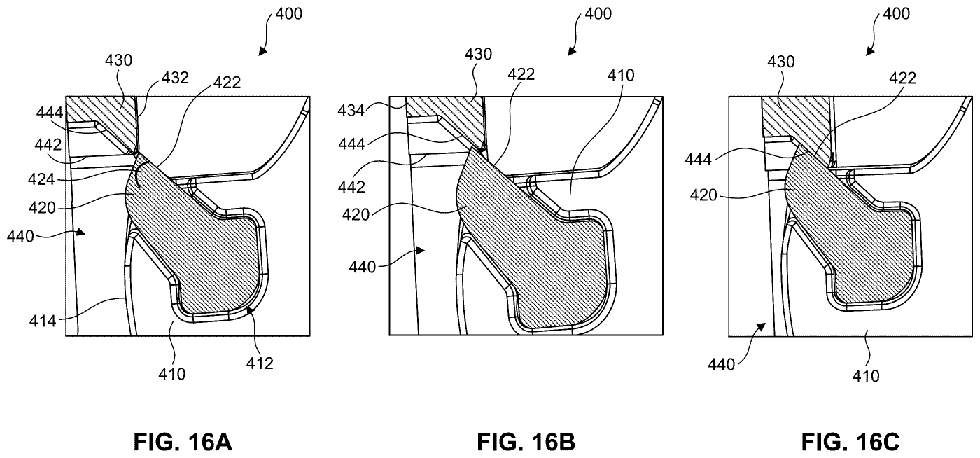

Locking mechanism 400 with catch 420 can provide additional safety functionality over a conventional tongue and groove locking mechanism. In some embodiments, catch 420 can contact angled surface 444 of aperture 440, when projection 410 is being translated out of aperture 440, to temporarily prevent disengagement of projection 410 from aperture 440, as shown, for example in FIG. 16C. This can be advantageous, for example, when load carrier 100 is in an in-use configuration and loaded with a heavy load, and a user mishandles actuator 350. Catch 420 can provide a safety stop to prevent projection 410 from disengaging aperture 440 such that the heavy load could cause base 110 to fall unintentionally to the lowered configuration. Catch 420 can require a user to intentionally actuate actuator 350 and lift handle assembly 300 to release catch 420 from angled surface 444 and aperture 440 to release locking mechanism 400.

In some embodiments, catch 420 can actively pull projection 410 into engagement with aperture 440. As shown, for example, in FIGS. 16A-C, as projection 410 and catch 420 pass nearby aperture 440, engagement surface 422 of catch 420 can engage angled surface 444. As the weight of load carrier 100 forces projection 410 and catch 420 upward, angle 424 of engagement surface 422 can cause a reaction force to pull catch 420 and projection 410 forward and into engagement with aperture 440 of receiver plate 430. This can be advantageous to provide a locking mechanism with an active and reliable engagement between projection 410 and aperture 440 and reduce the risk of projection 410 slipping out of aperture 440.

### Example Load Attachment Accessory

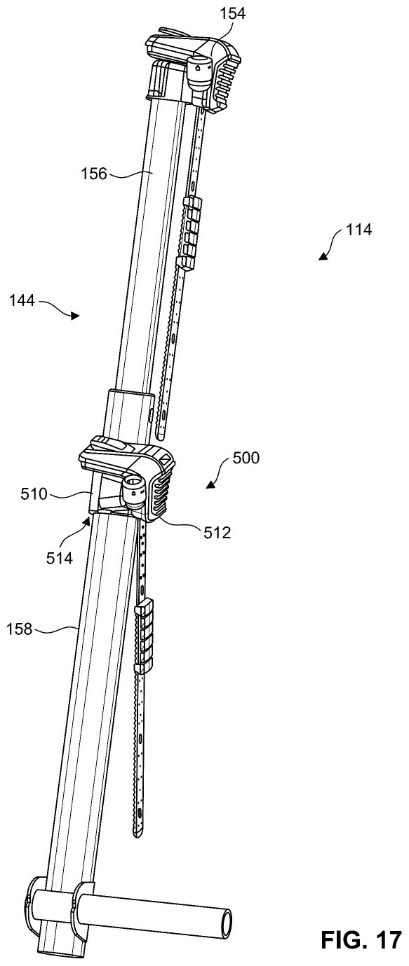

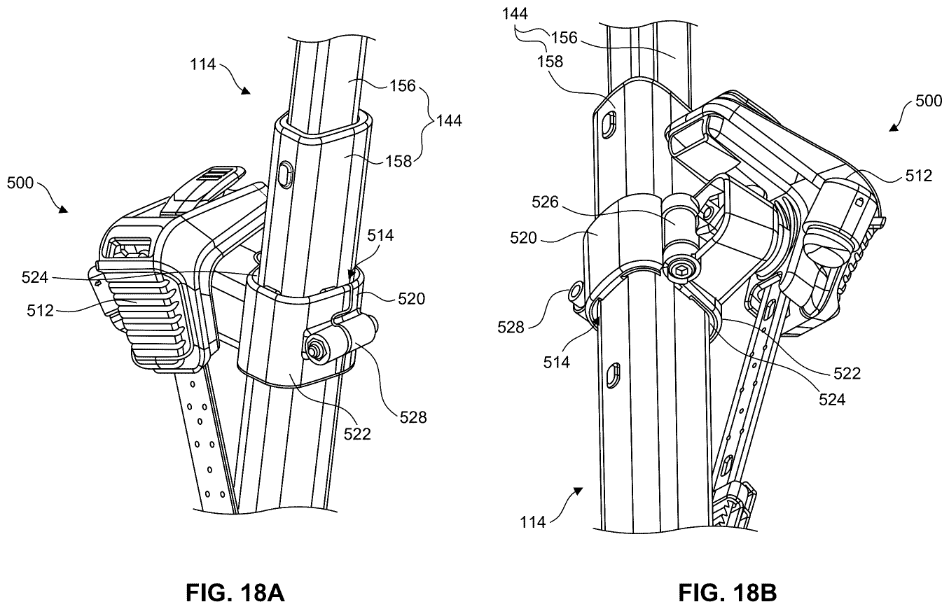

FIGS. 17, 18A, and 18B illustrate a load attachment accessory 500, according to embodiments. Load attachment accessory 500 can be configured to secure a smaller load, for example, a children's bicycle with wheel diameters less than 24 inches, to load carrier 100 than load securement arm 114 that for example, is configured to couple to bicycles having wheel diameters larger than 24 inches. In some embodiments, load attachment accessory 500 can increase load carrying versatility of load carrier 100, such that load carrier 100 can be adapted to secure a wider range of loads to load carrier 100. Load attachment accessory 500 can be an accessory component that can be removably coupled to load carrier 100. Although load attachment accessory 500 is shown in FIGS. 17, 18A, and 18B as a stand-alone system, the embodiments of this disclosure can be used with other apparatuses and/or systems, such as, but not limited to end cap 200, handle assembly 300, tilt-release locking mechanism 400, and repair stand 600.

In the illustrative embodiments shown in FIGS. 17, 18A, and 18B, load attachment accessory 500 can be removably coupled to load securement arm 114. In some embodiments, load securement arm 114 can be configured to secure a first load, for example, an adult, full-size bicycle with wheel diameters of 24, 26, and/or 29 inches, to load carrier 100, and load attachment accessory 500 can be configured to secure a second load, for example, a children's bicycle with wheel diameters less than 24 inches, that is smaller than the first load, to load carrier 100. In the illustrative embodiment shown in FIG. 17, load attachment accessory 500 can be removably coupled to outer arm 158 of load securement arm 114. In some embodiments, load attachment accessory 500 can be removably coupled to inner arm 156 of load securement arm 114. In some embodiments, load attachment accessory 500 can be coupled at any location along the length of load securement arm 114. In some embodiments, load attachment accessory 500 can be coupled a vertical support or cross-beam of a load carrier to secure a load thereto.

Load attachment accessory 500 can include bracket 510, load attachment member 512, and/or padding 514, as shown, for example, in FIGS. 17, 18A, and 18B. Bracket 510 can be configured to couple to load securement arm 114. In some embodiments, bracket 510 can be bolted directly to load securement arm 114, received in a slot formed in load securement arm 114, coupled to a bracket extending for load securement arm 114, or attached in another suitable manner. In the illustrative embodiment shown in FIG. 17, bracket 510 is a collar 510 that can couple to outer arm 158 of load securement arm 114. In some embodiments, padding 514 can be disposed between collar 510 and load securement arm 114. In some embodiments, padding 514 can reduce damage between collar 510 and load securement arm 114. In some embodiments, padding 514 can increase friction between collar 510 and load securement arm 114 to prevent collar 510 from slipping or translating relative to load securement arm 114.

In the illustrative embodiment shown in FIGS. 18A and 18B, collar 510 can include first shell 520, second shell 522, and inner surface 524. In some embodiments, first shell 520 and second shell 522 can surround load securement arm 114 to couple thereto. In some embodiments, first shell 520 and second shell 522 can be hingedly coupled together via hinge 526. In some embodiments, first and second shells 520, 522 can be openly pivoted away from each other via hinge 526 so that first and second shells 520, 522 can be removably coupled to load securement arm 114. In some embodiments, first and second shells 520, 522 can be hingedly coupled at hinge 526 and clamped on an opposite side by fastener 528. In some embodiments, fastener 528 can be a bolt, a quick-release lever mechanism, a clip, a latch, a hook and loop fastener, or any other suitable attachment mechanism. In some embodiments, first and second shells 520, 522 can completely surround an area of load securement arm 114. In some embodiments, first and second shells 520, 522 can partially surround load securement arm 114. In some embodiments, padding 514 can contact inner surface 524.

Load attachment member 512 can couple to collar 510 as shown, for example, in FIGS. 17, 18A, and 18B. In some embodiments, load attachment member 512 can be configured to secure a load to load carrier 100. In some embodiments, load attachment member 512 can be configured to secure to a bicycle frame, wheel, seat post, swing arm, fork, crank arm, or other suitable bicycle component. In some embodiments, load attachment member 512 rotatably coupled to collar 510 and configured to rotate relative to collar 510 about a single axis. In some embodiments, load attachment member 512 can be configured to rotate relative to collar 510 about multiple axes, for example, where load attachment member 512 is mounted via a ball joint to collar 510. In some embodiments, load attachment member 512 can be a strap head, a j-hook, or a clamp. In some embodiments, load attachment member 512 can be similar to the attachment device of load securement arm 114. In some embodiments, load attachment member 512 can be different to the attachment device of load securement arm 114.

### Example Repair Holder

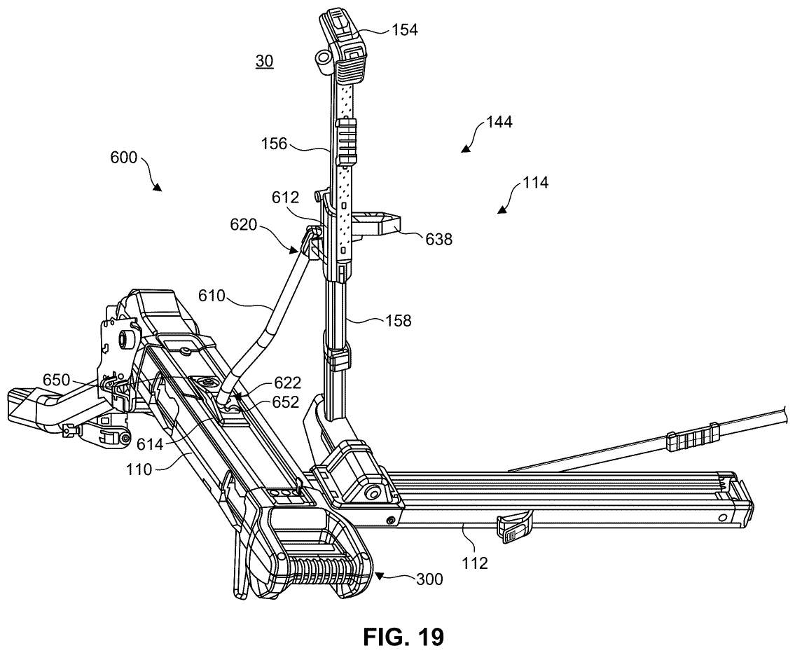

FIGS. 19-21 illustrate a repair stand 600 coupled to a load securement arm 114, according to embodiments. Repair stand 600 can be configured to support load securement arm 114 in a repair configuration 30 so that a load, for example, a bicycle, can be held upright by the load securement arm 114. Although repair stand 600 is shown in FIGS. 19-21 as a stand-alone system, the embodiments of this disclosure can be used with other apparatuses and/or systems, such as, but not limited to end cap 200, handle assembly 300, tilt-release locking mechanism 400, and load attachment accessory 500.

In the illustrative embodiment shown in FIG. 19, repair stand 600 can couple between load securement arm 114 and base 110 to support load securement arm 114 in a repair configuration 30. When the load securement arm 114 is in the repair configuration 30, attachment head 154 can secure a bicycle in an upright position so that it can be worked on or repaired. In some embodiments, repair stand 600 can coupled between load securement arm 114 and load support arm 112. In some embodiments, repair stand 600 can couple between load securement arm 114 and a support beam, such as a vehicle attachment portion, a vehicle, handle assembly 300, or another suitable supporting structure in proximity to load securement arm 114. In some embodiments, repair stand 600 can be removably coupled to load securement arm 114. In some embodiments, load carrier 100 can be moved between an in-use position and a tilt-down declined position (e.g., as shown in FIG. 19). In some embodiments, repair stand 600 can be configured to support load securement arm 114 in the repair configuration 30 in the in-use position. In some embodiments, repair stand 600 can be configured to support load securement arm 114 in the repair configuration 30 in the tilt-down declined position.

In some embodiments, repair stand 600 can include a support leg 610, a clamp 612, and a mounting head 614 as shown, for example in FIGS. 19-21. Support leg 610 can include a distal end 620 that couples to clamp 612 and a proximal end 622 that couples to mounting head 614. In some embodiments, support leg 610 is integrally formed with mounting head 614. In some embodiments, support leg 610 can be a bar, a tube, an elongated plate, or any other suitable structure for rigidly supporting load securement arm 114 in the repair configuration 30. In some embodiments, support leg 610 extends along a straight axis between distal end 620 and proximal end 622. In some embodiments, support leg 610 can be a non-straight lengthwise shape along a lengthwise axis. In some embodiments, support leg 610 can include a first portion extending along a first axis, a second portion extending along a second axis non-parallel to the first axis, and a third portion extending along a third axis non-parallel to the first or second axes. In some embodiments, support leg 610 can include a plurality of bends and straight portions between distal and proximal ends 620, 622.

Clamp 612 can couple to load securement arm 114 as shown, for example, in FIGS. 19 and 21. In some embodiments, clamp 612 can be removably coupled to load securement arm 114. In some embodiments, clamp 612 can couple to housing 158 of load securement arm 114. In some embodiments, clamp 612 can couple to telescoping arm 156 of load securement arm 114. In some embodiments, clamp 612 can be rotatably coupled to support leg 610.

Clamp 612 can include first shell 630 and second shell 632 as shown, for example, in FIG. 21. In some embodiments, first shell 630 and second shell 632 can surround load securement arm 114 to couple thereto. In some embodiments, first shell 630 and second shell 632 can be hingedly coupled together via hinge 634. In some embodiments, first and second shells 630, 632 can be openly pivoted away from each other via hinge 634 so that first and second shells 630, 632 can be removably coupled to load securement arm 114. In some embodiments, first and second shells 630, 632 can be hingedly coupled at hinge 634 and clamped on an opposite side by fastener 636. In some embodiments, fastener 636 can be a bolt, quick-release lever mechanism, clip, latch, hook and loop fastener, or any other suitable attachment mechanism. In some embodiments, first and second shells 630, 632 can completely surround a portion of load securement arm 114. In some embodiments, first and second shells 630, 632 can partially surround load securement arm 114. In some embodiments, clamp 612 can include a tool hanger 638 that extends away from first or second shell 630, 632 as shown, for example, in FIG. 19. Tool hanger 638 can be an arm, a hook, a loop, or similar shape, such that a bag or tools can be hung from tool hanger 638.

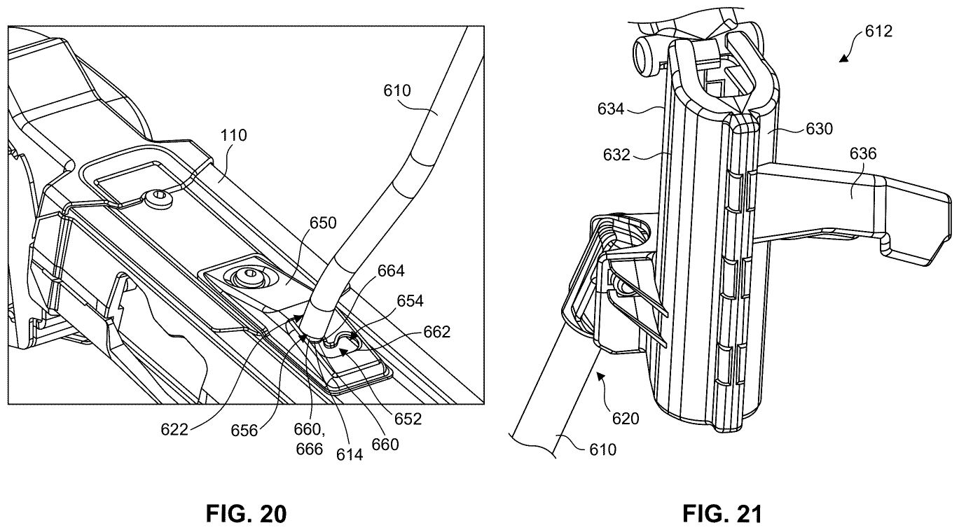

In some embodiments, mounting head 614 can be disposed at and/or couple to proximal end 622 of support leg 610 and be removably coupled to a mounting bracket 650 on base 110 as shown, for example, in FIGS. 19 and 20. In some embodiments, neck 640 can be disposed between mounting head 614 and support leg 610. In some embodiments, mounting head 614 can be removably coupled to support leg 610.

In the illustrative embodiment shown in FIGS. 19 and 20, mounting bracket 650 is coupled to base 110. In some embodiments, mounting bracket 650 can couple to any support beam such as, but not limited to, base 110, load support arm 112, a vehicle attachment portion, a vehicle, handle assembly 300, or another suitable supporting structure in proximity to load securement arm 114. In some embodiments, mounting bracket 650 can protrude from base 110. In some embodiments, mounting bracket 650 can include a coupling slot 652. Coupling slot 652 can be configured to receive mounting head 614 to removably couple therewith. In some embodiments, coupling slot 652 can be L-shaped. In some embodiments, coupling slot 652 can be straight, curved, non-linear, extend diagonally relative to mounting bracket 650, or any combination thereof. Coupling slot 652 can include an insertion end 654 and a fixing end 656. To assemble repair stand, mounting head 614 can be inserted into insertion end 654 of coupling slot 652 and then then slid along slot 652 to fixing end 656. In some embodiments, when a load is secured to load securement arm 114 in the repair configuration 30, support leg 610 is orientated such that it applies a lateral force on mounting head 614 to retain mounting head 614 in fixing end 656 of coupling slot 652.

As shown, for example, in FIG. 20, mounting head 614 can have a first width 660 that is smaller than a second width 662 at the insertion end 654 of coupling slot 652. In some embodiments, first width 660 of mounting head 614 is larger than a third width 664 of the fixing end 656 such that fixing end retains mounting head 614 in coupling slot 652. In some embodiments, neck 640 has a fourth width 666 that is less than each of first, second, and third widths 660, 662, 664 such that neck 640 can move along coupling slot 652 from insertion end 654 to fixing end 656.

It is to be appreciated that the Detailed Description section, and not the Brief Summary and Abstract sections, is intended to be used to interpret the claims. The Summary and Abstract sections may set forth one or more but not all embodiments of the vehicle rack system and apparatus, and thus, are not intended to limit the present embodiments and the appended claims.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

1. A bicycle carrier, comprising:
a base;
a wheel tray configured to receive a wheel of a bicycle, wherein the wheel tray comprises a proximal end coupled to the base and a distal end opposite the proximal end; and
a bicycle securement arm rotatably coupled to the wheel tray and configured to secure a bicycle to the bicycle carrier.

2. The bicycle carrier of claim 1, wherein the bicycle securement arm is disposed from the proximal end of the wheel tray by a first distance and from the distal end of the wheel tray by a second distance greater than the first distance.

3. (canceled)

4. The bicycle carrier of claim 1, wherein the bicycle securement arm comprises a bracket directly coupled to the wheel tray, a shaft rotatably mounted on the bracket, and an arm extending from the shaft and configured to rotate with the shaft.

5. (canceled)

6. The bicycle carrier of claim 4, wherein a groove extends from the proximal end to the distal end of the wheel tray, and wherein the bracket of the bicycle securement arm extends over the groove of the wheel tray.

7. The bicycle carrier of claim 4, wherein a groove extends from the proximal end to the distal end of the wheel tray, and wherein the bracket of the bicycle securement arm is disposed at least partially in the groove of the wheel tray.

8. (canceled)

9. The bicycle carrier of claim 4, wherein the bracket of the bicycle securement arm couples to side faces of the wheel tray.

10. (canceled)

11. The bicycle carrier of claim 1, wherein the bicycle securement arm is configured to secure a frame of the bicycle to the bicycle carrier.

12. The bicycle carrier of claim 1, wherein the bicycle securement arm is configured to rotate beyond a parallel orientation with the wheel tray when the bicycle securement arm is rotated toward the distal end of the wheel tray.

13. The bicycle carrier of claim 1, wherein the bicycle securement arm is prevented from reaching a parallel orientation with the wheel tray when the bicycle securement arm is rotated toward the base.

14. The bicycle carrier of claim 13, wherein a housing of the bicycle securement arm blocks movement of the bicycle securement arm from reaching a parallel orientation with the wheel tray when the bicycle securement arm is rotated toward the base.

15. A load carrier, comprising:
a base;
a reinforcement member coupled to a first side of the base; and
a load support arm coupled to the reinforcement member and configured to receive a load, wherein the reinforcement member extends into an interior of the load support arm.

16. The load carrier of claim 15, further comprising a load securement arm configured to secure a load to the load carrier, wherein the load securement arm couples to the load support arm and the reinforcement member.

17. The load carrier of claim 15, wherein the reinforcement member comprises a first assembly plate configured to couple to the first side of the base and a reinforcement arm extending from the first assembly plate.

18. (canceled)

19. The load carrier of claim 17, wherein an upper surface of the reinforcement arm contacts an upper internal surface of the load support arm.

20. The load carrier of claim 17, wherein the load support arm is coupled to the first assembly plate of the reinforcement member by a plurality of fasteners.

21. The load carrier of claim 17, further comprising:
a second reinforcement member coupled to a second side of the base opposite the first side of the base; and
a second load support arm coupled to the second reinforcement member, wherein the second reinforcement member comprises a second assembly plate and a second reinforcement arm.

22. The load carrier of claim 21, further comprising an assembly fastener configured to couple the first assembly plate and the second assembly plate to the base.

23. The load carrier of claim 22, wherein the assembly fastener extends through a first plate aperture in the first assembly plate, a first base aperture in the first side of the base, a second base aperture in the second side of the base, and a second plate aperture in the second assembly plate.

24. The load carrier of claim 23, wherein a shape of the first plate aperture is configured to prevent rotation of the assembly fastener.

25. (canceled)

26. (canceled)

27. The load carrier of claim 15, wherein the reinforcement member extends along between ten percent and thirty percent of a length of the load support arm.

28.-78. (canceled)
